(19) United States
(12) Patent Application Publication
(10) Pub. No.: US 2025/0358864 A1
(43) Pub. Date: Nov. 20, 2025

(54) METHOD AND APPARATUS FOR RANDOM ACCESS FOR REQUESTING AND PROVIDING SYSTEM INFORMATION IN WIRELESS COMMUNICATION SYSTEM

(71) Applicant: Samsung Electronics Co., Ltd., Gyeonggi-do (KR)

(72) Inventors: Seunghoon CHOI, Gyeonggi-do (KR); Junyung YI, Gyeonggi-do (KR)

(21) Appl. No.: 19/040,199

(22) Filed: Jan. 29, 2025

(30) Foreign Application Priority Data
May 17, 2024 (KR) 10-2024-0064423

(51) Int. Cl. H04W 74/0833; H04W 52/02

(52) U.S. Cl. CPC H04W 74/0833; H04W 52/0235

(57) ABSTRACT

The disclosure relates to a fifth generation (5G) or sixth generation (6G) communication system for supporting a higher data transmission rate and provides a random access method and apparatus for requesting and providing system information. A method performed by a terminal includes receiving, from a first BS, configuration information on a UL wake-up signal (WUS) for a second BS, transmitting, to the second BS, the UL WUS for requesting a system information block 1 (SIB1) associated with the second BS, receiving, from the second BS, a random access response based on the UL WUS, and receiving, from the second BS, the SIB1.

### CROSS-REFERENCE TO RELATED APPLICATION(S)

This application is based on and claims priority under 35 U.S.C. § 119 to Korean Patent Application No. 10-2024-0064423, which was filed in the Korean Intellectual Property Office on May 17, 2024, the entire disclosure of which is incorporated herein by reference.

### BACKGROUND

### 1. Field

The disclosure relates generally to operations of a terminal and a base station (BS) in a wireless communication system, and more particularly, to a method and an apparatus for saving energy in the terminal and the BS.

### 2. Description of Related Art

Fifth generation (5G) mobile communication technologies define broad frequency bands such that high transmission rates and new services are possible, and can be implemented in sub 6 gigahertz (GHz) bands such as 3.5 GHz, and also in above 6 GHz bands, which may be referred to as millimeter wave (mmWave) bands including 28 GHz and 39 GHz bands. In addition, it has been considered to implement sixth generation (6G) mobile communication technologies, referred to as beyond 5G systems, in terahertz (THz) bands such as 95 GHz to 3 THz bands to achieve transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE (UE) power waving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for NR to simplify random access procedures. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A wireless communication system is advancing to a broadband wireless communication system for providing high-speed and high-quality packet data services using communication standards, such as high-speed packet access (HSPA) of the third generation partnership project (3GPP), long term evolution-advanced (LTE-A), LTE-Pro, high-rate packet data (HRPD) of 3GPP2, ultra-mobile broadband (UMB), institute of electrical and electronics engineers (IEEE 802).17e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The UL refers to a radio link via which a UE or mobile station (MS) transmits data or control signals to a BS or eNode B, and the DL refers to a radio link via which the BS transmits data or control signals to the UE. The above multiple access scheme separates data or control information of respective users by allocating and operating time-frequency resources for transmitting the data or control information for each user so as to avoid overlapping each other, that is, to establish orthogonality.

Since a 5G communication system, which is a post-LTE communication system, must freely reflect various requirements of users, service providers, and the like, services satisfying various requirements must be supported. The services considered in the 5G communication system include eMBB, mMTC, URLLC, and the like.

eMBB aims at providing a data rate greater than that supported by existing LTE, LTE-A, or LTE-Pro. For example, in the 5G communication system, eMBB must provide a peak data rate of 20 gigabits per second (Gbps) in the DL and a peak data rate of 10 Gbps in the UL for a single BS. The 5G communication system must provide an increased user-perceived data rate to the UE, as well as the maximum data rate. To satisfy such requirements, there is a need in the art for improved transmission/reception technologies including further enhanced MIMO transmission. In addition, the data rate required for the 5G communication system may be obtained using a frequency bandwidth more than 20 megahertz (MHz) in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of many UEs in a cell, enhancement coverage of UEs, improved battery time, a reduction in the cost of a UE, and the like, to effectively provide the IoT. Since the IoT provides communication functions while being provided to various sensors and various devices, it must support many UEs (e.g., 1,000,000 UEs/km²) in a cell. In addition, the UEs supporting mMTC requires wider coverage than those of other services provided by the 5G communication system because the UEs are likely to be located in a shadow-ridden area, such as a basement of a building, which is not covered by the cell due to the nature of the service. The UE supporting mMTC must be configured to be inexpensive, and requires a very long battery life-time such as 10 to 15 years because it is difficult to frequently replace the battery of the UE.

URLLC is a cellular-based mission-critical wireless communication service that may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 milliseconds (ms) and may also require a packet error rate of 10-5 or less. Therefore, for the services supporting URLLC, a 5G system must provide a transmit time interval (TTI) shorter than those of other services and must assign many resources in a frequency band to secure reliability of a communication link.

The eMBB, URLLC, and mMTC may be multiplexed and transmitted in a single system. In this case, different transmission/reception techniques and transmission/reception parameters may be used between services to satisfy different requirements of the respective services.

With the recent development of environmentally friendly 5G/6G communication systems, there is a need in the art for a method and apparatus to reduce the energy consumption of a communication system for energy conservation purposes.

### SUMMARY

The disclosure has been made to address at least the above-mentioned problems and/or disadvantages and to provide at least the advantages described below.

Accordingly, an aspect of the disclosure is to provide a BS that may perform system information block 1 (SIB1) transmission in an on-demand format to reduce energy consumption in a communication system.

An aspect of the disclosure is to provide a BS that may receive a wake-up signal (WUS) from a terminal to transmit SIB1 according to the on-demand format and may transmit SIB1 upon receiving a WUS requesting SIB1 from the terminal, to provide a process of efficiently requesting and providing on-demand SIB1 using WUS.

An aspect of the disclosure is to provide, in a multi-cell scenario, a configuration for information of SIB1 and configuration information for WUS transmission through neighboring cells.

An aspect of the disclosure is to provide a configuration method via higher layer signaling (e.g., radio resource control (RRC) signaling) or a pre-configured/pre-fixed method for applying on-demand SIB1 operation.

In accordance with an aspect of the disclosure, a method performed by a terminal in a wireless communication system includes receiving, from a first BS, configuration information on a UL WUS for a second BS, transmitting, to the second BS, the UL WUS for requesting an SIB1 associated with the second BS, receiving, from the second BS, a random access response based on the UL WUS, and receiving, from the second BS, the SIB1.

In accordance with an aspect of the disclosure, a method performed by a second BS in a wireless communication system includes receiving, from a terminal, a UL WUS for requesting an SIB1 associated with the second BS, the UL WUS being based on configuration information on the UL WUS, transmitting, to the terminal, a random access response based on the UL WUS, and transmitting, to the terminal, the SIB1.

In accordance with an aspect of the disclosure, a terminal in a wireless communication system includes a transceiver; and a controller coupled with the transceiver and configured to receive, from a first BS, configuration information on a UL WUS for a second BS, transmit, to the second BS, the UL WUS for requesting an SIB1 associated with the second BS, receive, from the second BS, a random access response based on the UL WUS, and receive, from the second BS, the SIB1.

In accordance with an aspect of the disclosure, a second BS in a wireless communication system includes a transceiver, and a controller coupled with the transceiver and configured to receive, from a terminal, a UL WUS for requesting an SIB1 associated with the second BS, the UL WUS being based on configuration information on the UL WUS, transmit, to the terminal, a random access response based on the UL WUS, and transmit, to the terminal, the SIB1.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a time-frequency domain as a radio resource region in a wireless communication system according to an embodiment;

FIG. 2 illustrates a slot structure considered in a wireless communication system according to an embodiment;

FIG. 3 illustrates an example of a beam sweeping operation and a time domain mapping structure of a synchronization signal (SS) according to an embodiment;

FIG. 4 illustrates an SS block (SSB) considered in a wireless communication system according to an embodiment;

FIG. 5 illustrates various transmission cases of a SSB in a frequency band below 6 GHz considered in a wireless communication system according to an embodiment;

FIG. 6 illustrates transmission cases of SSBs in a frequency band of 6 GHz or higher considered in a wireless communication system according to an embodiment;

FIG. 7 illustrates transmission cases of a SSB according to SCS within a time of 5 ms in a wireless communication system according to an embodiment;

FIG. 8 illustrates an example of explaining demodulation reference signal (DMRS) patterns (e.g., type1 and type2) used for communication between a BS and a UE in a wireless communication system according to an embodiment;

FIG. 9 illustrates an example of channel estimation using a DMRS received from one physical UL shared channel (PUSCH) in a time band of a wireless communication system according to an embodiment;

FIG. 10 illustrates a method for configuring or an SSB and physical broadcast channel (PBCH) block transmission via dynamic signaling in a wireless communication system according to an embodiment;

FIG. 11 illustrates a method of reconfiguring a BWP and a bandwidth (BW) via dynamic signaling in a wireless communication system according to an embodiment;

FIG. 12 illustrates a method of reconfiguring discontinuous reception (DRX) via dynamic signaling in a wireless communication system according to an embodiment;

FIG. 13 illustrates an example of explaining a discontinuous transmission (DTX) method for BS energy saving according to an embodiment;

FIG. 14 illustrates an example of explaining an operation of a BS according to a gNB WUS according to an embodiment;

FIG. 15 illustrates an antenna adaptation method of a BS to save energy in a wireless communication system according to an embodiment;

FIG. 16 illustrates an example of on-demand SIB1 operation of a BS and a UE considering multiple cells according to an embodiment;

FIG. 17 illustrates an example of an on-demand SIB1 operation of a BS and a UE considering a single cell according to an embodiment;

FIG. 18 illustrates a provision of resource information required to receive UL WUS configuration information according to an embodiment;

FIG. 19 illustrates a provision of resource information required to receive UL WUS configuration information according to an embodiment;

FIG. 20 illustrates a provision of resource information required to receive UL WUS configuration information according to an embodiment;

FIG. 21 illustrates when a UE receives a WUS configuration from a specific cell, and then performs random access or camps on a NES cell during initial access according to information included in a WUS that the UE transmits, according to an embodiment;

FIG. 22 illustrates when a UE receives a WUS configuration from a specific cell, and then performs random access or camps on a NES cell during initial access according to information included in a WUS that the UE transmits, according to an embodiment;

FIG. 23 illustrates a UE operation of applying an energy saving method of a wireless communication system according to an embodiment;

FIG. 24 illustrates a BS operation of applying an energy saving method of a wireless communication system according to an embodiment;

FIG. 25 illustrates a UE according to an embodiment; and

FIG. 26 illustrates a BS according to an embodiment.

### DETAILED DESCRIPTION

The following description with reference to the accompanying drawings is provided to assist in a comprehensive understanding of the disclosure. It includes various specific details to assist in that understanding but these are to be regarded as merely examples. Accordingly, those of ordinary skill in the art will recognize that various changes and modifications of the various embodiments described herein can be made without departing from the scope and spirit of the disclosure. Descriptions of well-known functions and constructions may be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

In the following description, a BS is an entity that allocates resources to terminals and may be at least one of a next generation node B (gNode B), an evolved node B (eNode B), a Node B, a wireless access unit, a BS controller, and a node on a network. A terminal may include a UE, an MS, a cellular phone, a smartphone, a computer, or a multimedia system capable of performing a communication function. A DL refers to a radio link via which a BS transmits a signal to a terminal, and a UL refers to a radio link via which a terminal transmits a signal to a BS.

Herein, LTE or LTE-A systems may be described by way of example, but the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Hereinafter, a time-frequency domain resource and a frame structure of a 5G system will be described. For the sake of descriptive convenience, a configuration of a 5G system will be described but the embodiments of the disclosure may also be applied in the same or similar manner to higher systems or other communication systems to which the disclosure is applicable.

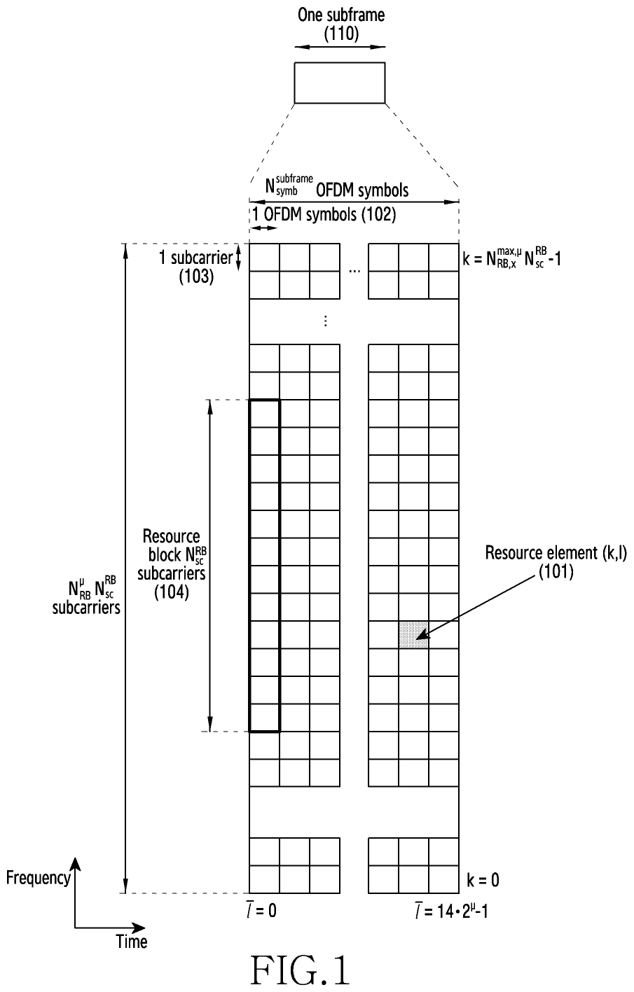

FIG. 1 illustrates a basic structure of a time-frequency domain as a radio resource region in a wireless communication system according to an embodiment.

Referring to FIG. 1, the horizontal axis denotes a time domain, and the vertical axis denotes a frequency domain. The basic unit of resources in the time-frequency domain is a resource element (RE) 101, which may be defined as one OFDM symbol 102 on the time axis and one subcarrier 103 on the frequency axis. In the frequency domain,

$${N}_{SC}^{RB}$$

(which denotes the number of subcarriers per resource block (RB), e.g., 12) consecutive REs may constitute one RB 104. Also, in the time domain,

$${N}_{slot}^{subframe , μ}$$

(which denotes the number of slots per subframe according to SCS configuration values μ) consecutive OFDM symbols may constitute one subframe 110.

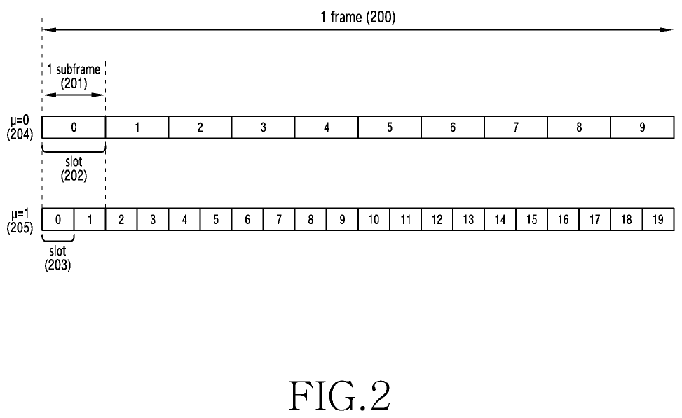

FIG. 2 illustrates a slot structure considered in a wireless communication system according to an embodiment.

Referring to FIG. 2, an example of a slot structure including a frame 200, a subframe 201, and a slot 202 or 203 is illustrated. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of slots per one slot

$$( {N}_{symb}^{slot} ) = 14 ) .$$

One subframe 201 may include one or multiple slots 202 or 203, and the number of slots 202 or 203 per one subframe 201 may vary depending on SCS configuration values μ 204 or 205.

FIG. 2 illustrates slot structures when the SCS configuration value is μ=0 (204) and when μ=1 (205). In μ=0 (204), one subframe 201 may include one slot 202, and in μ=1 (205), one subframe 201 may include two slots (for example, slots 203). That is, the number of slots per one subframe

$$( {N}_{slot}^{subframe , μ} )$$

may differ depending on the SCS configuration value μ, and the number of slots per one frame

$$( {N}_{slot}^{frame , μ} )$$

may differ accordingly.

$${N}_{slot}^{subframe , μ} and {N}_{slot}^{frame , μ}$$

may be defined according to each SCS configuration u as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the 5G wireless communication system, an SSB (SS block or SS/PBCH block may be interchangeably used) for initial access of a UE may be transmitted, and the SSB may include a primary synchronization signal (PSS), a secondary synchronization signal (SSS), and a PBCH.

During an initial access operation of a UE accessing a system, the UE may first acquire DL time and frequency domain synchronization from an SS via a cell search and may acquire a cell ID. The SS may include a PSS and an SSS. The UE may receive, from a BS, a PBCH for transmitting of a master information block (MIB) so as to acquire a basic parameter value and system information related to transmission and reception, such as a system bandwidth or related control information. Based on this information, the UE may perform decoding on a physical DL control channel (PDCCH) and a physical DL shared channel (PDSCH) so as to acquire an SIB. Then, the UE may exchange UE identification-related information with the BS via a random-access operation, and may initially access a network via registration and authentication operations. Additionally, the UE may receive an SIB transmitted by the BS to acquire cell-common transmission and reception-related control information. The cell-common transmission and reception-related control information may include random-access-related control information, paging-related control information, common control information for various physical channels, etc.

An SS serves as a reference for a cell search, and for each frequency band, an SCS may be applied adaptively to a channel environment, such as phase noise. For a data channel or a control channel, to support various services as described above, an SCS may be applied differently depending on a service type.

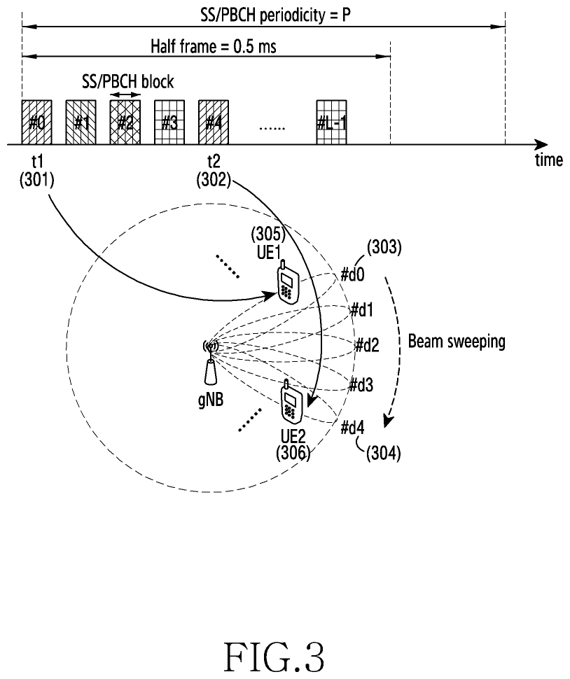

FIG. 3 illustrates an example of a beam sweeping operation and a time domain mapping structure of an SS according to an embodiment.

The PSS serves as a reference for DL time/frequency synchronization, and provides a part of cell identity (ID) information.

The SSS serves as a reference for DL time/frequency synchronization, and provides the other part of the cell ID information. Additionally, the SSS may serve as a reference signal for PBCH demodulation of a PBCH.

A PBCH provides an MIB which is mandatory system information required for transmission and reception of a data channel and a control channel of a UE. The mandatory system information may include search space-related control information indicating radio resource mapping information of a control channel, scheduling control information for a separate data channel for transmission of system information, a system frame number (SFN) which is a frame unit index that serves as a timing reference, and other information.

The SS/PBCH block is configured by N OFDM symbols and may include a combination of a PSS, an SSS, a PBCH, etc. For a system to which a beam sweeping technology is applied, an SS/PBCH block is a minimum unit to which beam sweeping is applied. In the 5G system, N=4 may be satisfied. A BS may transmit up to a maximum of L SS/PBCH blocks, and the L SS/PBCH blocks are mapped within a half frame (0.5 ms). In addition, the L SS/PBCH blocks are periodically repeated at predetermined periods P. The BS may inform a UE of period P via signaling. If there is no separate signaling of period P, the UE may apply a previously agreed default value.

Referring to FIG. 3, an example is shown wherein beam sweeping is applied in units of SS/PBCH blocks over time. UE 1 205 receives an SS/PBCH block by means of a beam emitted in direction #d0 303 by beamforming applied to SS/PBCH block #0 at time point t1 301. In addition, UE 2 306 receives an SS/PBCH block by means of a beam emitted in direction #d4 304 by beamforming applied to SS/PBCH block #4 at time point t2 302. The UE may acquire, from the BS, an optimal synchronization signal via a beam emitted in the direction where the UE is located. For example, it may be difficult for UE 1 305 to acquire time/frequency synchronization and mandatory system information from the SS/PBCH block through the beam emitted in direction #d4 far away from the location of UE 1.

In addition to the initial access procedure, for the purpose of determining whether the radio link quality of a current cell is maintained at a certain level or higher, the UE may also receive the SS/PBCH block. Furthermore, during a handover procedure in which the UE moves access from the current cell to an adjacent cell, the UE may receive an SS/PBCH block of the adjacent cell to determine the radio link quality of the adjacent cell and acquire time/frequency synchronization with the adjacent cell.

An SS serves as a reference for a cell search, and may be transmitted by applying of an SCS appropriate for a channel environment (e.g., phase noise) for each frequency band. A 5G BS may transmit multiple SSBs according to the number of analog beams to be operated. For example, a PSS and an SSS may be mapped and transmitted over 12 RBs, and a PBCH may be mapped and transmitted over 24 RBs.

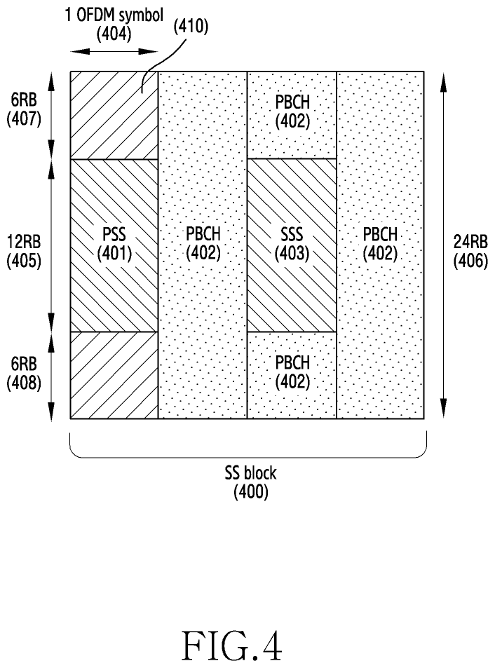

FIG. 4 illustrates an SSB considered in a wireless communication system according to an embodiment.

Referring to FIG. 4, the SSB (SS block) 400 may include a PSS 401, an SSS 403, and a PBCH 402.

The SSBs 400 may be mapped to four OFDM symbols 404 on the time axis. The PSS 401 and SSS 403 may be transmitted in 12 RBs 405 on the frequency axis, and in the first and third OFDM symbols, respectively, on the time axis. In a 5G system, for example, a total of 1008 different cell IDs may be defined. Depending on the physical cell ID (PCI) of the cell, the PSS 401 may have three different values, and the SSS 403 may have 336 different values. Via detection of the PSS 401 and SSS 403, the UE may obtain one of the (336×3=)1008 cell IDs, based on a combination thereof, as expressed in Equation (1) below.

$${N}_{ID}^{c e l l} = 3 {N}_{ID}^{( 1 )} + {N}_{ID}^{( 2 )} \qquad ( 1 )$$

In Equation (1),

$${N}_{ID}^{( 1 )}$$

may be estimated from the SSS 403, and may have a value between 0 and 335.

$${N}_{ID}^{( 2 )}$$

may be estimated from the PSS 401, and may have a value between 0 and 2. The UE may estimate a value of

$${N}_{ID}^{( c e l l )} ,$$

which is a cell ID, by using a combination of

$${N}_{ID}^{( 1 )} and {N}_{ID}^{( 2 )} .$$

In 24 RBs 406 on the frequency axis and in a second or a fourth OFDM symbol of the SS block on the time axis, the PBCH 402 may be transmitted in resources including 6 RBs 407 and 408 on both sides, excluding 12 RBs 405 while the SSS 403 is being transmitted. The PBCH 402 may include a PBCH payload and a PBCH DMRS, and various system information referred to as MIB may be transmitted in the PBCH payload. For example, the MIB includes information as in Table 2 below.

TABLE 2

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | , |
| cellBarred | ENUMERATED {barred, notBarred}, |
| intraFreqReselection | ENUMERATED {allowed, notAllowed}, |
| spare | BIT STRING (SIZE (1)) |

}

SSB information is an offset of the frequency domain of the SSB may be indicated via 4-bit ssb-SubcarrierOffset in an MIB. An index of the SSB including the PBCH may be obtained indirectly via decoding of the PBCH DMRS and the PBCH. In a frequency band below 6 GHz, 3 bits acquired via decoding of the PBCH DMRS may indicate the SSB index, and in a frequency band of 6 GHz or higher, a total of 6 bits, which includes 3 bits acquired via decoding of the PBCH DMRS and 3 bits which are included in the PBCH payload and acquired from PBCH decoding, may indicate the SSB index including the PBCH.

In PDCCH configuration information, an SCS of a common DL control channel may be indicated via 1 bit (subCarrierSpacingCommon) in an MIB, and time-frequency resource configuration information of a search space (SS) and a control resource set (CORESET) of ID 0 may be indicated via 8 bits (pdcch-ConfigSIB1). The CORESET of ID 0 may be referred to as controlResourceSetZero and the search space of ID 0 may be referred to as searchspaceZero. In the disclosure, the CORESET of ID 0 may be referred to as CORESET #0 or control area #0 for convenience, and the search space of ID 0 may be referred to as search space #0 for convenience. During initial access of a cell, the UE may receive, via the above pdcch-ConfigSIB1, a configuration of the frequency resource indicating the number of RBs, etc. of the CORESET #0 including the common search space set of the Type0-PDCCH CSS set and the time resource indicating the number of OFDM symbols, etc.

As to the SFN, in an MIB, 6 bits (systemFrameNumber) may be used to indicate a part of an SFN. 4 bits (e.g., least significant bit (LSB)) of the SFN may be included in the PBCH payload and indirectly acquired by the UE via PBCH decoding.
as to timing information in a radio frame, timing information is 1 bit (half frame) which is included in the aforementioned SSB index and PBCH payload, and acquired via PBCH decoding, and the UE may indirectly identify whether the SSB has been transmitted in a first or second half frame of a radio frame.

The transmission bandwidth (12 RBs 405) for the PSS 401 and the SSS 403 is different from the transmission bandwidth (24 RBs 406) for the PBCH 402, and thus, in a first OFDM symbol in which the PSS 401 is transmitted within the PBCH 402 transmission bandwidth, there exist 6 RBs 407 and 6 RBs 408 on both sides excluding 12 RBs while the PSS 401 is being transmitted, and the area may be used for transmitting another signal or may be empty.

Cell access allowance information concerns whether camping (or camping on) a cell is allowed may be indicated through 1 bit (cellBarred) in the MIB. In addition, when camping on a cell with the best reception quality is barred, 1 bit (intraFreqReselection) in the MIB may indicate when cell reselection is allowed for intra-frequency cells.

SSBs may be transmitted using the same analog beam. For example, the PSS 401, the SSS 403, and the PBCH 402 are all transmitted via the same beam. Since analog beams cannot be applied differently to the frequency axis, the same analog beam may be applied to all frequency axis RBs within a specific OFDM symbol to which a specific analog beam has been applied. For example, the four OFDM symbols on which the PSS 401, the SSS 403, and the PBCH 402 are all transmitted via the same analog beam.

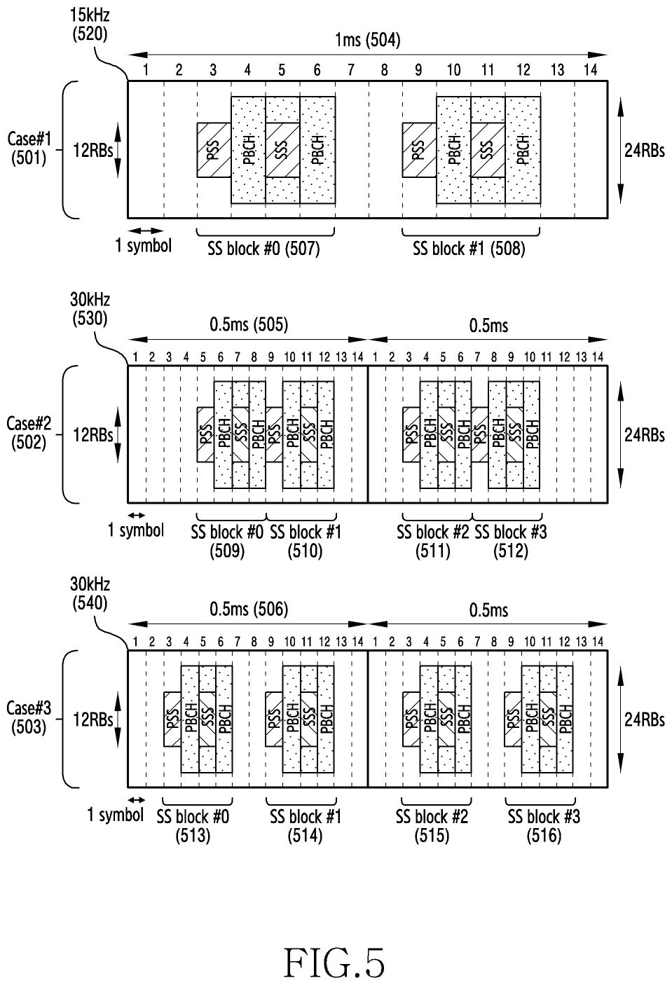

FIG. 5 illustrates various transmission cases of a SSB in a frequency band below 6 GHz considered in a wireless communication system according to an embodiment.

Referring to FIG. 5, in a 5G communication system, an SCS 520 of 15 kHz and a SCS 530 or 540 of 30 kHz may be used for SSB transmission in a frequency band of 6 GHz or lower (or frequency range 1 (FR1), e.g., 410 MHz-7125 MHz). There may be one transmission case (e.g., case #1 501) for a SSB in the SCS 520 of 15 kHz, and there may be two transmission cases (e.g., case #2 502 and case #3 503) for a SSB in the SCS 530 or 540 of 30 kHz.

In case #1 501 with the SCS 520 of 15 kHz, a maximum of 2 SSBs may be transmitted in 1 ms of time 504 (or corresponding to a length of one slot when one slot includes 14 OFDM symbols). In an example of FIG. 4, SSB #0 507 and SSB #1 508 are illustrated. For example, SSB #0 507 may be mapped to 4 consecutive symbols starting from a third OFDM symbol, and SSB #1 508 may be mapped to 4 consecutive symbols starting from a ninth OFDM symbol.

Different analog beams may be applied to SSB #0 507 and SSB #1 508. In addition, the same beam may be applied to all of the third to sixth OFDM symbols to which SSB #0 507 is mapped, and the same beam may be applied to all of the ninth to 12th OFDM symbols to which SSB #1 508 is mapped. With regard to beams to be used for seventh, eighth, 13th, and 14th OFDM symbols to which no SSB is mapped, an analog beam may be freely determined at the discretion of a BS.

Referring to FIG. 5, in case #2 502 with the SCS 530 of 30 kHz, a maximum of 2 SSBs may be transmitted in 0.5 ms of time 505 (or corresponding to a length of one slot when one slot includes 14 OFDM symbols), and accordingly, a maximum of 4 SSBs may be transmitted in 1 ms of time (or corresponding to a length of two slots when one slot includes 14 OFDM symbols). In an example of FIG. 5, a case in which SSB #0 509, SSB #1 510, SSB #2 511, and SSB #3 512 are transmitted in 1 ms of time (i.e., two slots) is illustrated. SSB #0 509 and SSB #1 510 may be mapped starting from a 5th OFDM symbol and a 9th OFDM symbol of a first slot, respectively, and SSB #2 511 and SSB #3 512 may be mapped starting from a 3rd OFDM symbol and a 7th OFDM symbol of a second slot, respectively.

Different analog beams may be applied to SSB #0 509, SSB #1 510, SSB #2 511, and SSB #3 512, respectively. In addition, the same analog beam may be applied to all of fifth to eighth OFDM symbols of a first slot in which SSB #0 509 is transmitted, ninth to 12th OFDM symbols of the first slot in which SSB #1 510 is transmitted, third to sixth symbols of a second slot in which SSB #2 511 is transmitted, and seventh to 10th symbols of the second slot in which SSB #3 512 is transmitted. With regard to beams to be used for OFDM symbols to which no SSB is mapped, analog beams may be freely determined at the discretion of a BS.

Referring to FIG. 5, in case #3 503 with the SCS 540 of 30 kHz, a maximum of 2 SSBs may be transmitted in 0.5 ms of time 506 (or corresponding to a length of one slot when one slot includes 14 OFDM symbols), and accordingly, a maximum of 4 SSBs may be transmitted in 1 ms of time (or corresponding to a length of two slots when one slot includes 14 OFDM symbols). In an example of FIG. 5, transmission of SSB #0 513, SSB #1 514, SSB #2 515, and SSB #3 516 in 1 ms of time (i.e., two slots) is illustrated. SSB #0 513 and SSB #1 514 may be mapped starting from a third OFDM symbol and a ninth OFDM symbol of a first slot, respectively, and SSB #2 515 and SSB #3 516 may be mapped starting from a third OFDM symbol and a ninth OFDM symbol of a second slot, respectively.

Different analog beams may be used for SSB #0 513, SSB #1 514, SSB #2 515, and SSB #3 516, respectively. As described in the examples above, the same analog beam may be used for all 4 OFDM symbols in which respective SSBs are transmitted, and in OFDM symbols to which no SSB is mapped, beams to be used may be freely determined at the discretion of a BS.

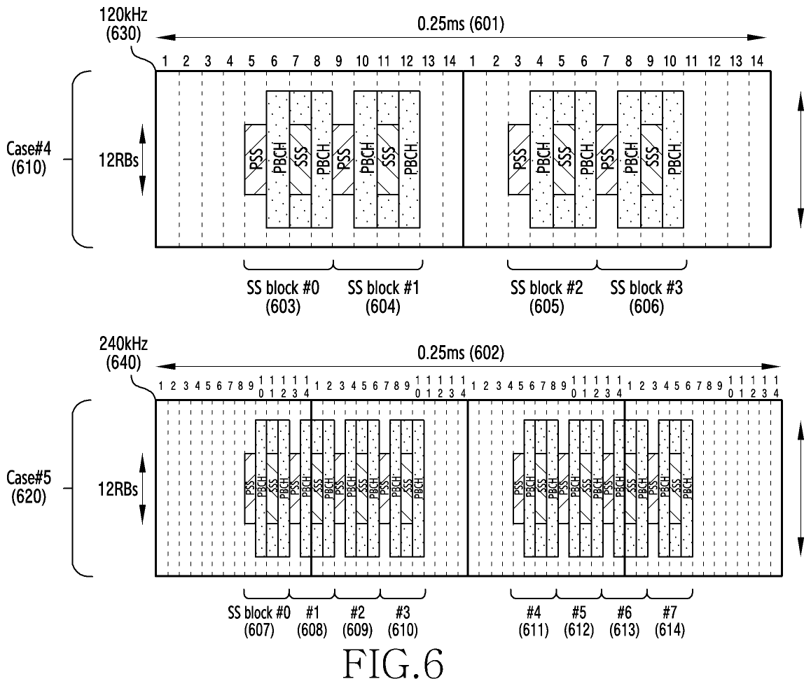

FIG. 6 illustrates transmission cases of SSBs in a frequency band of 6 GHz or higher considered in a wireless communication system according to an embodiment.

Referring to FIG. 6, in a wireless communication system, in a frequency band of 6 GHz or higher (or FR2, e.g., 24250 MHz-52000 MHz), an SCS 630 of 120 kHz as shown in case #4 610 and an SCS 640 of 240 kHz as shown in case #5 620 may be used for SSB transmission.

In case #4 610 with the SCS 630 of 120 kHz, a maximum of 4 SSBs may be transmitted in 0.25 ms of time 601 (or corresponding to a length of two slots when one slot includes 14 OFDM symbols). In an example of FIG. 6, a case where SSB #0 603, SSB #1 604, SSB #2 605, and SSB #3 606 are transmitted in 0.25 ms of time (i.e., two slots) is illustrated. SSB #0 603 and SSB #1 604 may be respectively mapped to 4 consecutive symbols starting from a fifth OFDM symbol and to 4 consecutive symbols starting from a ninth OFDM symbol of a first slot, and SSB #2 605 and SSB #3 606 may be respectively mapped to 4 consecutive symbols starting from a third OFDM symbol and to 4 consecutive symbols starting from a seventh OFDM symbol of a second slot.

As described in the embodiment above, different analog beams may be used for SSB #0 603, SSB #1 604, SSB #2 605, and SSB #3 606, respectively. In addition, the same analog beam may be used for all 4 OFDM symbols in which respective SSBs are transmitted, and in OFDM symbols to which no SSB is mapped, beams to be used may be freely determined at the discretion of a BS.

In case #5 620 with the SCS 640 of 240 kHz, a maximum of 8 SSBs may be transmitted in 0.25 ms of time 602 (or corresponding to a length of 4 slots when one slot includes 14 OFDM symbols). In an example of FIG. 6, a case where SSB #0 607, SSB #1 608, SSB #2 609, SSB #3 610, SSB #4 611, SSB #5 612, SSB #6 613, and SSB #7 614 are transmitted in 0.25 ms of time (i.e., 4 slots) is illustrated.

SSB #0 607 and SSB #1 608 may be respectively mapped to 4 consecutive symbols starting from a ninth OFDM symbol and to 4 consecutive symbols starting from a 13th OFDM symbol of a first slot, SSB #2 609 and SSB #3 610 may be respectively mapped to 4 consecutive symbols starting from a third OFDM symbol and to 4 consecutive symbols starting from a seventh OFDM symbol of a second slot, SSB #4 611, SSB #5 612, and SSB #6 613 may be respectively mapped to 4 consecutive symbols starting from a fifth OFDM symbol, to 4 consecutive symbols starting from a ninth OFDM symbol, and to 4 consecutive symbols starting from a 13th OFDM symbol of a third slot, and SSB #7 614 may be mapped to 4 consecutive symbols starting from a third OFDM symbol of a fourth slot.

As described in the embodiment above, different analog beams may be applied to SSB #0 607, SSB #1 608, SSB #2 609, SSB #3 610, SSB #4 611, SSB #5 612, SSB #6 613, and SSB #7 614, respectively. In addition, the same analog beam may be used for all 4 OFDM symbols in which respective SSBs are transmitted, and in OFDM symbols to which no SSB is mapped, beams to be used may be freely determined at the discretion of a BS.

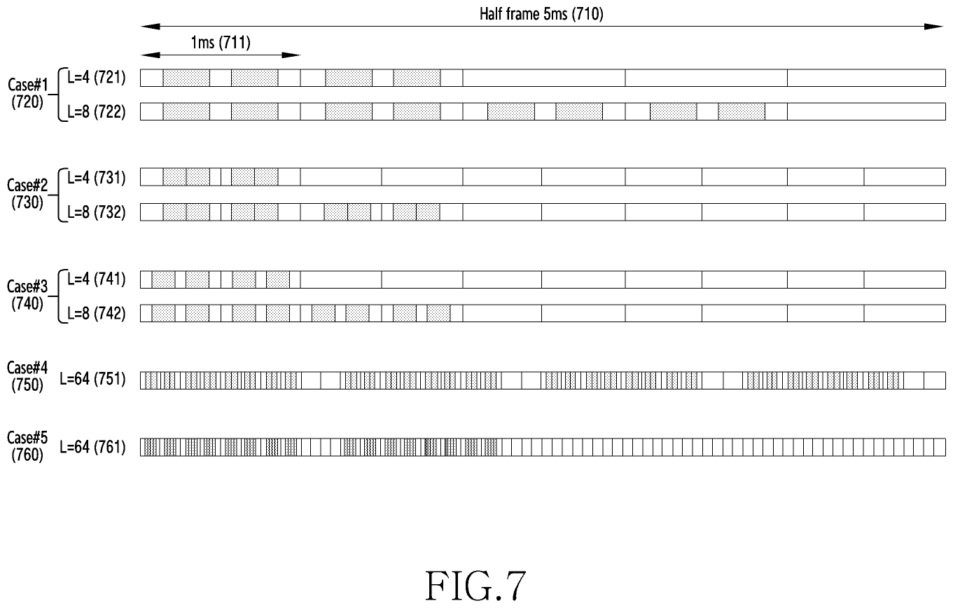

FIG. 7 illustrates transmission cases of blocks of synchronization signals according to SCS within a time of 5 ms in a wireless communication system according to an embodiment.

Referring to FIG. 7, in a 5G communication system, SSBs are transmitted periodically, for example, in units of time intervals 710 of 5 ms (corresponding to 5 subframes or a half frame).

In a frequency band of less than or equal to 3 GHz, a maximum of 4 SSBs may be transmitted within 5 ms of time 710. In a frequency band greater than 3 GHz and less than or equal to 6 GHz, a maximum of 8 SSBs may be transmitted. In a frequency band greater than 6 GHz, a maximum of 64 SSBs may be transmitted. As described above, SCSs of 15 kHz and 30 kHz may be used at a frequency of 6 GHz or lower.

In case #1 720 including one slot with the SCS of 15 kHz, SSBs may be mapped to a first slot and a second slot so that a maximum of 4 SSBs 721 may be transmitted in a frequency band of less than or equal to 3 GHz, and SSBs may be mapped to first, second, third, and fourth slots so that a maximum of 8 SSBs 722 may be transmitted in a frequency band greater than 3 GHz and less than or equal to 6 GHz. In case #2 730 or case #3 740 including two slots with the SCS of 30 kHz, SSBs may be mapped starting from a first slot so that a maximum of 4 SSBs 731 and 741 may be transmitted in a frequency band of less than or equal to 3 GHz, and SSBs may be mapped starting from first and third slots so that a maximum of 8 SSBs 732 and 742 may be transmitted in a frequency band greater than 3 GHz and less than or equal to 6 GHz.

The SCSs of 120 kHz and 240 kHz may be used at a frequency greater than 6 GHz. In case #4 750 including two slots with the SCS of 120 kHz, SSBs may be mapped starting from first, third, fifth, seventh, 11th, 13th, 15th, 17th, 21st, 23rd, 25th, 27th, 31st, 33rd, 35th, and 37th slots so that a maximum of 64 SSBs 751 may be transmitted in a frequency band greater than 6 GHz. In case #5 760 including 4 slots with the SCS of 240 kHz, SSBs may be mapped starting from first, fifth, ninth, 13th, 21st, 25th, 29th, and 33rd slots so that a maximum of 64 SSBs 761 may be transmitted in a frequency band greater than 6 GHz.

Based on the system information included in the received MIB, the UE may decode the PDCCH and PDSCH and obtain SIB1 or SIBx (all remaining SIBs except for SIB1). SIB1 may include at least one of information related to UL cell bandwidth, random access parameters, paging parameters, or parameters related to UL power control.

The UE may establish a radio link with a network via a random access procedure, based on synchronization with the network and system information acquired during a cell search process of the cell. A contention-based or contention-free scheme may be used for random access. When the UE performs cell selection and reselection during an initial cell access operation, for example, for the purpose of moving from an RRC_IDLE (RRC idle) state to an RRC_CONNECTED (RRC connected) state, the contention-based random-access scheme may be used. Contention-free random access may be used to re-establish UL synchronization in a case of DL data arrival, handover, or positioning.

Table 3 below illustrates conditions (events) for triggering random access in the 5G system.

TABLE 3
Initial access from RRC_IDLE;
RRC Connection Re-establishment procedure;
DL or UL data arrival during RRC_CONNECTED when UL
synchronisation status is “non-synchronised”;
UL data arrival during RRC_CONNECTED when there are no PUCH
resources for SR available;
SR failure;
Request by RRC upon synchronous reconfiguration (e.g. Handover);
RRC Connection Resume procedure from RRC_INACTIVE;
To establish time alignment for a secondary TAG;
Request for Other SI;
Beam failure recovery;
Consistent UL LBT failure on SpCell.

In a 5G communication system, the BS may assign one or more BWPs to the UE, and for each BWP, the BS may assign the information included in Table 4 below.

TABLE 4

| BWP ::= | SEQUENCE { |
|---|---|
| bwp-Id | BWP-Id, |
| locationAndBandwidth | INTEGER (1..65536), |
| subcarrierSpacing | ENUMERATED {n0, |
| n1, n2, n3, n4, n5}, | |
| cyclicPrefix | ENUMERATED |

{ extended }
}

In addition to the above configuration information, various parameters related to the BWP may be configured to the UE. The information may be transferred by the BS to the UE via higher layer signaling, e.g., RRC signaling. At least one BWP of the configured one or more BWPs may be activated. Whether the configured BWP is activated may be transferred semi-statically from the BS to the UE via RRC signaling or dynamically via DL control information (DCI).

Prior to RRC connection, the UE may receive a configuration of the initial BWP for the initial access from the BS through MIB or SIB1.

Specifically describing the configuration of control area #0, search space #0, and an initial BWP, the UE may receive the configuration information for control area #0 and search space #0 via the MIB during the initial access phase, in which a PDCCH may be transmitted to receive the system information (which may correspond to remaining system information (RMSI) or SIB1) required for the initial access. The control area and search space configured by the MIB may be considered as ID 0, respectively. The BS may notify the UE of configuration information such as frequency allocation information, time allocation information, and numerology for control area #0 through the MIB. In addition, the BS may notify the UE of the monitoring period and occasion for control area #0 through the MIB, i.e., the configuration information for search space #0.

In the above method of configuring the initial BWP, UEs before RRC connection (RRC_Connected) may receive the configuration information for the initial BWP via the MIB during the initial access phase. More specifically, the UE may receive from the MIB of the PBCH a CORESET for the DL control channel through which the DCI scheduling of the SIB may be transmitted. The BW of the control region configured by the MIB may be considered as the initial BWP, and the configured initial BWP allows the UE to receive the PDSCH in which the SIB is transmitted. In addition to receiving SIBs, the initial BWP may also be used for other system information (OSI), paging, and random access.

Hereinafter, a description will be provided for a measurement time configuration method for radio resource management (RRM) based on an SS block or SSB of the 5G wireless communication system.

The UE may be configured with MeasObjectNR of MeasObjectToAddModList for SSB-based intra/inter-frequency measurements and CSI-RS-based intra/inter-frequency measurements via higher layer signaling. For example, MeasObjectNR is configured as shown in Table 5 below.

TABLE 5

| | |
|---|---|
| MeasObjectNR ::= | SEQUENCE { |

| | |
|---|---|
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | , |

| | |
|---|---|
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS- |
| BlocksToAverage) | OPTIONAL, -- Need R |
| nrofCSI-RS-ResourcesToAverage | INTEGER (2..maxNrofCSI-RS- |
| ResourcesToAverage) | OPTIONAL, -- Need R |
| quantityConfigIndex | INTEGER |

(1..maxNrofQuantityConfig),

| | |
|---|---|
| offsetMO | Q-OffsetRangeList, |
| cellsToRemoveList | PCI-List |

OPTIONAL, -- Need N
cellsToAddModList
OPTIONAL, -- Need N

| | |
|---|---|
| blackCellsToRemoveList | PCI-RangeIndexList |
| OPTIONAL, -- Need N | |
| blackCellsToAddModList | SEQUENCE (SIZE |
| (1..maxNrofPCI-Ranges)) OF PCI-RangeElement | OPTIONAL, -- Need |
| N | |
| whiteCellsToRemoveList | PCI-RangeIndexList |
| OPTIONAL, -- Need N | |
| whiteCellsToAddModList | SEQUENCE (SIZE |
| (1..maxNrofPCI-Ranges)) OF PCI-RangeElement | OPTIONAL, -- Need |

```
N
  ...,
  [[
  freqBandIndicatorNR
OPTIONAL, -- Need R
```

| | |
|---|---|
| measCycleSCell | ENUMERATED {sf160, sf256, |

```
sf320, sf512, sf640, sf1024, sf1280} OPTIONAL -- Need R
  ]],
  [[
```

| | | |
|---|---|---|
| smtc3list-r16 | SSB-MTC3List-r16 | OPTIONAL, -- |

Need R

| | | |
|---|---|---|
| rmtc-Config-r16 | SetupRelease {RMTC-Config-r16} | OPTIONAL, -- |

Need M

| | | |
|---|---|---|
| t312-r16 | SetupRelease { T312-r16 } | OPTIONAL - |

- Need M
]]
}

The terms in Table 5 may perform, but are not limited to, the following functions.

ssbFrequency: A frequency of a synchronization signal related to MeasObjectNR may be configured.

ssbSubcarrierSpacing: An SCS of SSB may be configured. Only 15 kHz or 30 kHz may be applied for FR1, and only 120 kHz or 240 kHz may be applied for FR2.

smtc1: An SS/PBCH block measurement timing configuration (SMTC), a primary measurement timing configuration may be configured, and a timing offset and duration for SSB may be configured.

smtc2: A secondary measurement timing configuration for SSB related to MeasObjectNR having a PCI listed in pci-List may be configured.

The SMTC may be configured via other higher layer signaling. For example, SMTC is configured for the UE via reconfigurationWithSync for NR primary secondary cell group (SCG) cell (PSCell) change and NR primary cell (PCell) change or SIB2 for intra-frequency, inter-frequency, and inter-RAT cell reselection, and SMTC may also be configured for the UE via SCellConfig for adding an NR secondary cell (SCell).

The UE may configure a first SMTC according to periodicityAndOffset (providing periodicity and offset) via smtc1 configured via higher layer signaling for SSB measurement. A first subframe of each SMTC occasion may start from a subframe of an SpCell and an SFN which satisfy conditions in Table 6 below.

TABLE 6

```
SFN mod T = (FLOOR (Offset/10));
if the Periodicity is greater than sf5:
  subframe = Offset mod 10;
else:
  subframe = Offset or (Offset +5);
with T = CEIL(Periodicity/10).
```

If smtc2 is configured, for cells indicated by pci-List values of smtc2 in the same MeasObjectNR, the UE may configure an additional SMTC according to the periodicity of configured smtc2 and the offset and duration of smtc1. In addition, for the same frequency (e.g., a frequency for intra frequency cell reselection) or different frequencies (e.g., frequencies for inter frequency cell reselection), the UE may be configured with smtc and measure an SSB, via smtc3list for smtc2-LP (with long periodicity) and integrated access and backhaul-mobile termination (IAB-MT). The UE may not consider an SSB transmitted in a subframe other than an SMTC occasion for SSB-based RRM measurement in configured ssbFrequency.

Depending on a serving cell configuration and physical cell identifier (PCI) configuration, the BS may use various multi-transmit/receive point or transmission and reception point (TRP) operation schemes. When two TRPs at physically distant locations have different PCIs, there may be two methods for operating the two TRPs.

### Method 1

Two TRPs having different PCIs may be operated with two serving cell configurations.

The BS may include, in different serving cell configurations, channels and signals transmitted in different TRPs to configure the same using Method 1. In other words, each TRP may have an independent serving cell configuration, and the frequency band values FrequencyInfoDLs indicated by DLConfigCommon in each serving cell configuration may indicate bands at least partially overlap each other. Since multiple TRPs operate based on multiple ServCellIndexes (e.g., ServCellIndex #1 and ServCellIndex #2), respective TRPs may use separate PCIs. In other words, the BS may assign one PCI for each ServCellIndex.

In this case, when multiple SSBs are transmitted in TRP 1 and TRP 2, the SSBs have different PCIs (e.g., PCI #1 and PCI #2), and the BS may appropriately select a value of ServCellIndex indicated by a cell parameter in quasi-colocation (QCL)-Info so as to map a PCI appropriate for each TRP, and may designate an SSB transmitted in either TRP 1 or TRP 2 as a source reference RS for QCL configuration information. However, since this configuration is to apply one serving cell configuration that can be used for carrier aggregation (CA) of the UE to multiple TRPs, there is a problem of restricting a degree of freedom in CA configuration or increasing signaling burden.

### Method 2

Two TRPs having different PCIs may be operated with one serving cell configuration.

The BS may configure, through one serving cell configuration, channels and signals transmitted in different TRPs using Method 2. Since the UE operates based on one ServCellIndex (e.g., ServCellIndex #1), it is not possible to recognize the PCI (e.g., PCI #2) assigned to the second TRP.

Method 2 may have a degree of freedom in CA configuration as compared with method 1 described above. However, when multiple SSBs are transmitted in TRP 1 and TRP 2, the SSBs may have different PCIs (e.g., PCI #1 and PCI #2), and the BS may be unable to map the PCI (e.g., PCI #2) of the second TRP via ServCellIndex indicated by a cell parameter in QCL-Info. The BS may be able to designate only an SSB transmitted in TRP 1 as a source reference RS of QCL configuration information, and may be unable to designate an SSB transmitted in TRP 2.

As described above, method 1 may perform multi-TRP operation for two TRPs having different PCIs through an additional serving cell configuration without additional specification support, but method 2 may operate based on additional UE capability reporting and BS configuration information as described below.

### UE Capability Report for Method 2

The UE may report, to the BS through UE capability, that configuration of an additional PCI different from a PCI of a serving cell is possible from the BS via higher layer signaling. The UE capability may include X1 and X2 which are numbers independent of each other, or each of X1 and X2 may be reported via independent UE capability.

X1 refers to the maximum number of additional PCIs configurable for the UE. A PCI may be different from the PCI of the serving cell. X1 may indicate when the time domain position and periodicity of the SSB corresponding to the additional PCI are the same as those of an SSB of the serving cell.

X2 refers to the maximum number of additional PCIs configurable to the UE. In this case, a PCI may be different from the PCI of the serving cell and the time domain position and periodicity of the SSB corresponding to the additional PCI are different from those of the SSB corresponding to the PCI reported with X1.
By definition, PCIs corresponding to values reported with X1 and X2 may not be configured simultaneously.

The values reported with X1 and X2 reported through the UE capability report may each have an integer value from 0 to 7.

The values reported with X1 and X2 may be reported as different values in FR1 and FR2.

### Higher Layer Signaling Configuration for Method 2

The UE may receive configuration of SSB-MTCAdditionalPCI-r17, which is higher layer signaling, from the BS, based on the UE capability report described above. The higher layer signaling may at least include a plurality of additional PCIs having values different from a value of the serving cell, SSB transmission power corresponding to each additional PCI, and ssb-PositionInBurst corresponding to each additional PCI. The maximum number of additional PCIs that can be configured may be seven.

As an assumption on an SSB corresponding to an additional PCI having a value different from that of a serving cell, the UE may assume that a center frequency, an SCS, and a subframe number offset for the SSB is the same as that for the SSB of the serving cell.

The UE may assume that a reference RS (e.g., SSB or CSI-RS) corresponding to the PCI of the serving cell is always connected to an activated transmission configuration indication (TCI) state. When there are one or more additionally configured PCIs having values different from the value of the serving cell, the UE may assume that only one PCI among the PCIs is connected to the activated TCI state.

When the UE has received configuration of two different corsesetPoolIndexes, the reference RS corresponding to the serving cell PCI is connected to one or more activated TCI states, and a reference RS corresponding to the additionally configured PCI having a value different from that of the serving cell is connected to one or more activated TCI states, the UE may expect that the activated TCI state(s) connected to the serving cell PCI is connected to one coresetPoolIndex out of two, and that the activated TCI state(s) connected to the additionally configured PCI having a value different from that of the serving cell is connected to the remaining one coresetPoolIndex.

Via the higher layer signaling of a BS and UE capability reporting for method 2 described above, the additional PCI having a value different from that of the PCI of the serving cell may be configured. When there is no configuration, the SSB, which cannot be designated by a source reference RS and which corresponds to the additional PCI having a value different from that of the PCI of the serving cell, may be used to designate a source reference RS of QCL configuration information and to serve as a QCL source RS to support operations of multiple TRPs having different PCIs, unlike the SSB configurable to be used for purposes, such as RRM, mobility, or handover, such as configuration information about the SSB configurable in smtc1 and smtc2 of higher layer signaling.

The DMRS may include multiple DMRS ports, and each of the ports may maintain orthogonality by using code division multiplexing (CDM) or frequency division multiplexing (FDM) to prevent interference with each other. However, the term DMRS may be expressed in other terms depending on a user's intention or the purpose of using the reference signal.

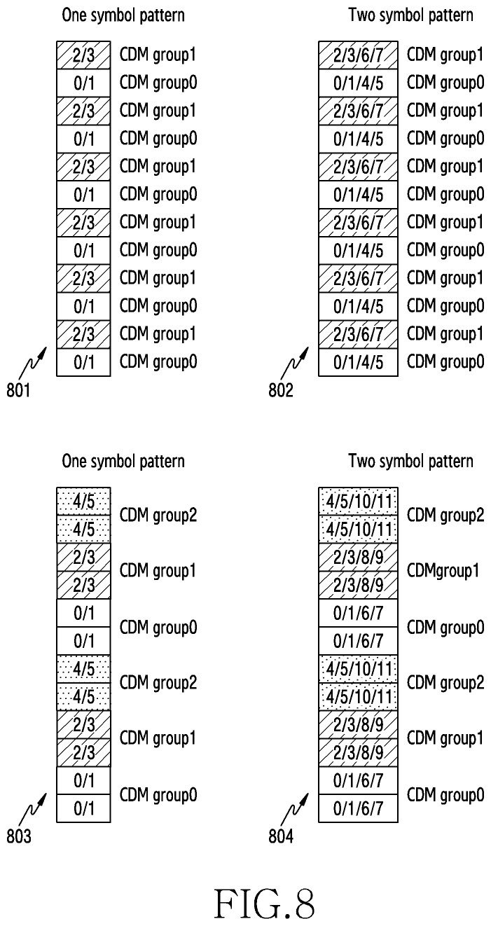

FIG. 8 illustrates an example of explaining DMRS patterns (type1 and type2) used for communication between a BS and a UE in a wireless communication system according to an embodiment.

In the 5G system, two DMRS patterns may be supported.

Referring to FIG. 8, DMRS type1 801, 802 indicating a 1-symbol pattern 801 and a 2-symbol pattern 802 are shown. DMRS type1 801, 802 is a DMRS pattern with a comb 2 structure which may include two CDM groups, and the different CDM groups may be FDMed.

In the 1-symbol pattern 801, CDM on frequency may be applied to the same CDM group so that two DMRS ports may be distinguished, and thus, a total of four orthogonal DMRS ports may be configured. The 1-symbol pattern 801 may include a DMRS port ID mapped to each CDM group (e.g., a DMRS port ID for DL may be indicated by an illustrated number+1000). In the 2-symbol pattern 802, CDM on time/frequency may be applied to the same CDM group so that four DMRS ports may be distinguished, and therefore a total of eight orthogonal DMRS ports may be configured. The 2-symbol pattern 802 may include a DMRS port ID mapped to each CDM group (e.g., a DMRS port ID for DL may be indicated by an illustrated number+1000).

In FIG. 8, DMRS type2 803, 804 is a DMRS pattern with a structure in which frequency domain orthogonal cover codes (FD-OCCs) are applied to a subcarrier adjacent on frequency, and may include three CDM groups, and different CDM groups may be FDMed.

In the 1-symbol pattern 803, CDM on frequency may be applied to the same CDM group so that two DMRS ports may be distinguished, and thus, a total of six orthogonal DMRS ports may be configured. The 1-symbol pattern 803 may include a DMRS port ID mapped to each CDM group (e.g., a DMRS port ID for DL may be indicated by an illustrated number+1000). In the 2-symbol pattern 704, CDM on time/frequency may be applied to the same CDM group so that four DMRS ports may be distinguished, and therefore a total of 12 orthogonal DMRS ports may be configured. The 2-symbol pattern 804 may include a DMRS port ID mapped to each CDM group (e.g., a DMRS port ID for DL may be indicated by an illustrated number+1000).

As described above, in an NR system, two different DMRS patterns (e.g., the DMRS type1 801, 802 or the DMRS type2 803, 804) may be configured, and whether each DMRS pattern is a one-symbol pattern 801 or 803 or is an adjacent two-symbol pattern 802 or 804 may also be configured. In the NR system, not only a DMRS port number may be scheduled, but also the number of CDM groups scheduled together for PDSCH rate matching may be configured and signaled. In cyclic prefix (CP)-OFDM, both the two DMRS patterns described above may be supported in DL and UL, and in a discrete Fourier transform spread OFDM (DFT-S-OFDM), only DMRS type1 801, 802 among the DMRS patterns described above may be supported in UL.

An additional configurable DMRS may also be supported. A front-loaded DMRS may refer to a first DMRS transmitted and received in a front-most symbol in the time domain from among DMRSs, and an additional DMRS may refer to a DMRS transmitted and received in a symbol subsequent to the front-loaded DMRS in the time domain. In the NR system, the number of additional DMRSs may be configured to be a minimum of 0 to a maximum of 3. When an additional DMRS is configured, the same pattern as the front-loaded DMRS may be assumed. When information on whether the aforementioned DMRS pattern type for the front-loaded DMRS is type1 or type2, information on whether the DMRS pattern is a one-symbol pattern or is an adjacent two-symbol pattern and information on a DMRS port and the number of CDM groups used are indicated, and when information on DMRS port and the number of CDM groups used are indicated, if an additional DMRS is additionally configured, the additional DMRS may be assumed to be configured with the same DMRS information as that for the front-loaded DMRS.

The DL DMRS configuration described above may be configured via RRC signaling as shown in Table 7 below.

TABLE 7

| | |
|---|---|
| DMRS-DownlinkConfig ::= | SEQUENCE { |
| dmrs-Type | ENUMERATED {type2} |

OPTIONAL, -- Need S

| | |
|---|---|
| dmrs-AdditionalPosition | ENUMERATED {pos0, pos1, pos3} |

OPTIONAL, -- Need S

| | |
|---|---|
| maxLength | ENUMERATED {len2} |

OPTIONAL, -- Need S

| | |
|---|---|
| scramblingID0 | INTEGER (0..65535) |

OPTIONAL, -- Need S

| | |
|---|---|
| scramblingID1 | INTEGER (0..65535) |

OPTIONAL, -- Need S

| | |
|---|---|
| phaseTrackingRS | SetupRelease {PTRS-DownlinkConfig} |

OPTIONAL, -- Need M
...
}

In Table 7, dmrs-Type may configure a DMRS type, dmrs-AdditionalPosition may configure additional DMRS OFDM symbols, maxLength may configure a 1-symbol DMRS pattern or a 2-symbol DMRS pattern, scramblingID0 and scramblingID1 may configure scrambling IDs, and phaseTrackingRS may configure a phase tracking reference signal (PTRS).

In addition, the UL DMRS configuration described above may be configured via RRC signaling as shown in Table 8 below.

TABLE 8

| | |
|---|---|
| DMRS-UplinkConfig ::= | SEQUENCE { |
| dmrs-Type | ENUMERATED {type2} |

OPTIONAL, -- Need S

| | |
|---|---|
| dmrs-AdditionalPosition | ENUMERATED {pos0, pos1, pos3} |

OPTIONAL, -- Need R

| | |
|---|---|
| phaseTrackingRS | SetupRelease { PTRS-UplinkConfig } |

OPTIONAL, -- Need M

| | |
|---|---|
| maxLength | ENUMERATED {len2} |

OPTIONAL, -- Need S

| | |
|---|---|
| transformPrecodingDisabled | SEQUENCE { |
| scramblingID0 | INTEGER (0..65535) |

OPTIONAL, -- Need S

| | |
|---|---|
| scramblingID1 | INTEGER (0..65535) |

```
OPTIONAL, -- Need S
    ...
  }
OPTIONAL, -- Need R
```

| | |
|---|---|
| transformPrecodingEnabled | SEQUENCE { |
| nPUSCH-Identity | INTEGER (0..1007) |

OPTIONAL, -- Need S

| | |
|---|---|
| sequenceGroupHopping | ENUMERATED {disabled} |

OPTIONAL, -- Need S

| | |
|---|---|
| sequenceHopping | ENUMERATED {enabled} |

```
OPTIONAL, -- Need S
    ...
  }
OPTIONAL, -- Need R
  ...
}
```

In Table 8, dmrs-Type may configure a DMRS type, dmrs-AdditionalPosition may configure additional DMRS OFDM symbols, phaseTrackingRS may configure a PTRS, and maxLength may configure a 1-symbol DMRS pattern or a 2-symbol DMRS pattern. ScramblingID0 and scramblingID1 may configure scrambling ID0s, nPUSCH-Identity may configure a cell ID for DFT-s-OFDM, sequenceGroupHopping may disable sequence group hopping, and sequenceHopping may enable sequence hopping.

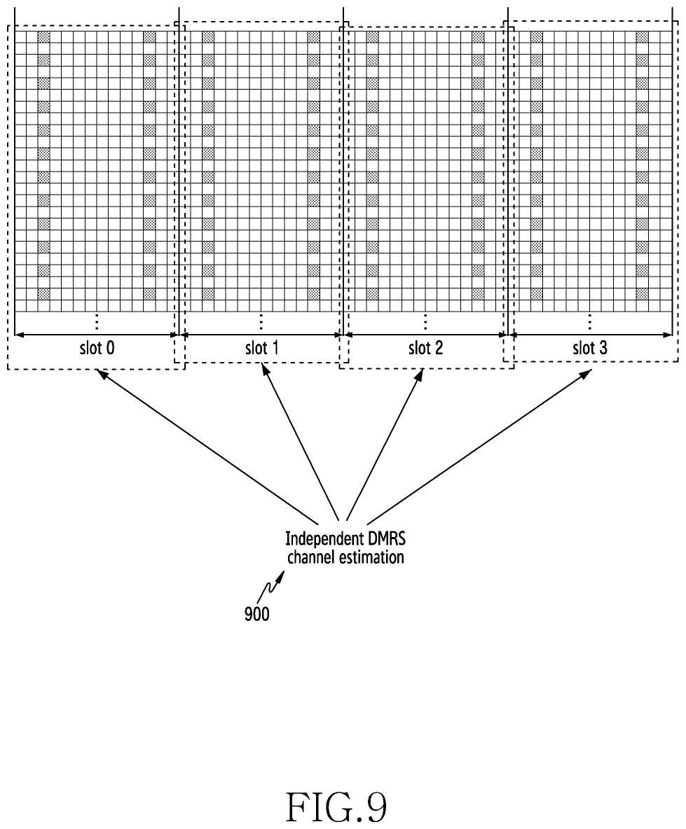

FIG. 9 illustrates an example of channel estimation using DMRS received from one PUSCH in a time band of a wireless communication system according to an embodiment.

Referring to FIG. 9, when performing channel estimation for data decoding using a DMRS, the independent DMRS channel estimation 900 may be performed within a precoding RB group (PRG), which is a corresponding bundling unit, by using physical RB (PRB) bundling linked to a system band in a frequency band. In addition, the channel estimation 900 may be performed by assuming that, in a time unit, only a DMRS received from one PUSCH has the same precoding.

The BS may configure a table for time domain resource allocation (TDRA) information regarding a PDSCH and a PUSCH for a UE through upper layer signaling (for example, RRC signaling).

The BS may configure a table including a maximum number of DL allocations equals 17 (maxNrofDL-Allocations=17) entries for the PDSCH and may configure a table including a maximum of maxNrofUL-Allocations=17 entries for the PUSCH. The TDRA information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like.

The TDRA information for the PDSCH, as given in Table 9 below, may be configured to the UE through RRC signaling.

TABLE 9
PDSCH-TimeDomainResourceAllocationList information element

PDSCH-TimeDomainResourceAllocationList ::= SEQUENCE
(SIZE(1..maxNrofDL-Allocations)) OF PDSCH-TimeDomainResourceAllocation
PDSCH-TimeDomainResourceAllocation ::= SEQUENCE {

| | |
|---|---|
| k0 | INTEGER(0..32) |

OPTIONAL, -- Need S

| | |
|---|---|
| mappingType | ENUMERATED {typeA, typeB}, |
| startSymbolAndLength | INTEGER (0..127) |
| repetitionNumber | ENUMERATED {n2, n3, n4, n5, n6, n7, n8, n16} |

OPTIONAL, -- Cond Formats1-0and1-1
}

In Table 9, k0 may denote PDCCH-to-PDSCH timing (i.e., a slot offset between DCI and a PDSCH scheduled thereby) in slot unit, mappingType may denote the mapping type of the PDSCH, startSymbolAndLength may denote a start symbol of the PDSCH and the length thereof, and repetitionNumber may denote the number of transmission occasions of the PDSCH according to slot-based repetition schemes.

The TDRA information for the PUSCH, as given in Table 10 below, may be configured to the UE through RRC signaling.

TABLE 10
PUSCH-TimeDomainResourceAllocation information element

| | |
|---|---|
| PUSCH-TimeDomainResourceAllocationList ::= | SEQUENCE |

(SIZE(1..maxNrofUL-Allocations)) OF PUSCH-TimeDomainResourceAllocation

| | |
|---|---|
| PUSCH-TimeDomainResourceAllocation ::= | SEQUENCE { |
| k2 | INTEGER(0..32) |

OPTIONAL, -- Need S

| | |
|---|---|
| mappingType | ENUMERATED {typeA, typeB}, |
| startSymbolAndLength | INTEGER (0..127) |

}

| | |
|---|---|
| PUSCH-Allocation-r16 ::= | SEQUENCE { |

| | |
|---|---|
| mappingType-r16 | ENUMERATED {typeA, typeB} |

OPTIONAL, -- Cond NotFormat01-02-Or-TypeA

| | | |
|---|---|---|
| startSymbolAndLength-r16 | INTEGER (0..127) | OPTIONAL, -- Cond |

NotFormat01-02-Or-TypeA

| | | |
|---|---|---|
| startSymbol-r16 | INTEGER (0..13) | OPTIONAL, -- Cond |

RepTypeB

| | | |
|---|---|---|
| length-r16 | INTEGER (1..14) | OPTIONAL, -- Cond |

RepTypeB

| | |
|---|---|
| numberOfRepetitions-r16 | ENUMERATED {n1, n2, n3, n4, n7, n8, n12, n16} |

OPTIONAL, -- Cond Format01-02
...
}

In Table 10, k2 may denote PDCCH-to-PUSCH timing (i.e., a slot offset between DCI and a PUSCH scheduled thereby) in slot unit, mappingType may denote the mapping type of the PUSCH, startSymbolAndLength or StartSymbol and length may denote a start symbol of the PUSCH and the length thereof, and numberOfRepetitions may denote the number of repetitions applied to transmission of the PUSCH.

The BS may indicate, to the UE, at least one of the entries of the TDRA information table through layer 1 (L1) signaling (for example, DCI) indicated by “TDRA” field within the DCI. The UE may acquire TDRA information regarding a PDSCH or PUSCH, based on the DCI acquired from the BS.

PUSCH transmission may be dynamically scheduled by a UL grant inside DCI (for example, referred to as dynamic grant (DG)-PUSCH), or may be scheduled by means of configured grant (CG) Type 1 or Type 2, referred to as CG-PUSCH. Dynamic scheduling for PUSCH transmission may be indicated by DCI format 0_0 or 0_1.

CG Type 1 PUSCH transmission may be configured semi-statically by receiving configuredGrantConfig including rrc-ConfiguredUplinkGrant in Table 17 through upper signaling, without receiving a UL grant inside DCI. CG Type 2 PUSCH transmission may be scheduled semi-persistently by a UL grant inside DCI after receiving configuredGrantConfig not including rrc-ConfiguredUplinkGrant in Table 17 through upper signaling.

If PUSCH transmission is operated by a CG, parameters applied to the PUSCH transmission are applied through configuredGrantConfig (upper signaling) in Table 16 except for dataScramblingIdentityPUSCH, txConfig, codebookSubset, maxRank, and scaling of UCI-OnPUSCH, which are provided by pusch-Config (upper signaling) in Table 18. If provided with transformPrecoder inside configuredGrantConfig (upper signaling) in Table 18, the UE applies tp-pi2BPSK inside pusch-Config in Table 11 to PUSCH transmission operated by a CG.

TABLE 11
ConfiguredGrantConfig

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..17), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |

```
  sym2, sym7, sym1x14, sym2x14, sym4x14, sym5x14, sym8x14, sym10x14,
sym17x14, sym20x14,
  sym32x14, sym40x14, sym64x14, sym80x14, sym128x14, sym170x14,
sym256x14, sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym17x12,
sym20x12, sym32x12,
  sym40x12, sym64x12, sym80x12, sym128x12, sym170x12, sym256x12,
sym320x12, sym512x12, sym640x12,
  sym1280x12, sym2560x12
  },
```

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..16), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..16) |

OPTIONAL, -- Need R

| | |
|---|---|
| mcsAndTBS | INTEGER (0..31), |
| frequencyHoppingOffset | INTEGER (1.. |

maxNrofPhysicalResourceBlocks-1) OPTIONAL, -- Need R

| | |
|---|---|
| pathlossReferenceIndex | INTEGER (0..maxNrofPUSCH- |

```
PathlossReferenceRSs-1),
    ...
  }
OPTIONAL, -- Need R
  ...
}
```

The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 12 below, which is upper signaling, is “codebook” or “nonCodebook”. As described above, PUSCH transmission may be dynamically scheduled through DCI format 0_0 or 0_1, and may be semi-statically configured by a CG.

Upon receiving indication of scheduling regarding PUSCH transmission through DCI format 0_0, the UE may perform beam configuration for PUSCH transmission by using pucch-spatialRelationInfoID corresponding to a UE-specific PUCCH resource having the minimum ID inside an activated UL BWP in a serving cell. The PUSCH transmission may be performed based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 12, the UE does not expect scheduling through DCI format 0_1.

TABLE 12
PUSCH-Config

| | |
|---|---|
| PUSCH-Config ::= | SEQUENCE { |

| | |
|---|---|
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS- |
| UplinkConfig } OPTIONAL, -- Need M | |
| dmrs-UplinkForPUSCH-MappingTypeB | SetupRelease { DMRS- |
| UplinkConfig } OPTIONAL, -- Need M | |
| pusch-PowerControl | OPTIONAL, -- |

Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |
| maxNrofPhysicalResourceBlocks-1) | OPTIONAL, -- Need M |
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |

| | |
|---|---|
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| transformPrecoder | ENUMERATED {enabled, disabled} | |
|---|---|---|
| OPTIONAL, -- Need S | | |
| codebookSubset | ENUMERATED | {fullyAndPartialAndNonCoherent, |

partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

The codebook-based PUSCH transmission may be dynamically scheduled through DCI format 0_0 or 0_1, and may be operated semi-statically by a CG. If a codebook-based PUSCH is dynamically scheduled through DCI format 0_1 or configured semi-statically by a CG, the UE determines a precoder for PUSCH transmission, based on an SRS resource indicator (SRI), a transmission precoding matrix indicator (TPMI), and a transmission rank (the number of PUSCH transmission layers).

The SRI may be given through the SRI (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI may be used to indicate a precoder to be applied to PUSCH transmission.

The precoder to be used for PUSCH transmission may be selected from a UL codebook having the same number of antenna ports as the value of nrofSRS-Ports inside SRS-Config (upper signaling). In connection with codebook-based PUSCH transmission, the UE may determine a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the BS.

If the UE reported “partialAndNonCoherent” as UE capability, the UE may not expect that the value of codebookSubset (upper signaling) will be configured as “fullyAndPartialAndNonCoherent”. In addition, if the UE reported “noncoherent” as UE capability, the UE may not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the BS, one or multiple SRS resources included in the SRS resource set wherein the value of usage is configured as “codebook” according to upper signaling, and the BS selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the BS may add information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

As described above, PUSCH transmission may be dynamically scheduled through DCI format 0_0 or 0_1 and may be semi-statically configured by a CG. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one non-zero-power (NZP) CSI-RS resource associated with the SRS resource set may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS may be indicated by an SRS request which is a field inside DCI format 0_1 or 1_1. In an embodiment, if the NZP CSI-RS resource associated with the SRS-ResourceSet is an aperiodic NZP CSI-RS resource and the value of field SRS request inside DCI format 0_1 or 1_1 is not “00”, this case may indicate the existence of the NZP CSI-RS associated with the SRS-ResourceSet. The DCI may not indicate cross carrier or cross BWP scheduling. If the value of SRS request indicates the existence of a NZP CSI-RS, the NZP CSI-RS may be located in the slot used to transmit the PDCCH including the SRS request field. TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE may not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the BS. The SRI may be indicated through the SRI (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the BS by the UE. SRS resources simultaneously transmitted by the UE may occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The BS may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the BS, one or multiple SRS resources inside the SRS resource set wherein the configured usage is “nonCodebook”, and the BS may select one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the BS may be the number of transmission layers of the PUSCH, and the UE may transmit the PUSCH by applying the precoder applied to SRS resource transmission to each layer.

The 5G system may support two types of repeated transmission methods of the UL data channel (e.g., PUSCH repeated transmission type A, PUSCH repeated transmission type B) and transport block (TB) processing over multi-slot PUSCH (TBoMS) for transmitting a single TB through multiple PUSCHs over multiple slots. In addition, the UE may receive configuration of either PUSCH repeated transmission type A or B via higher layer signaling. In addition, the UE may transmit a TBoMS by receiving configuration of numberOfSlotsTBoMS via a resource allocation table.

### PUSCH Repeated Transmission Type A

As described above, within one slot, by a TDRA method, a start symbol and a length of a UL data channel may be determined, and the BS may transmit the number of repeated transmissions to the UE via higher layer signaling (e.g., RRC signaling) or L1 signaling (e.g., DCI). To determine the TB size (TBS), the number N of the slots configured via numberOfSlotsTBoMS may be 1.

The UE may repeatedly transmit a UL data channel, which has the same start symbol and length as those configured in the UL data channel, in consecutive slots, based on the number of repeated transmissions received from the BS. In an embodiment, in case that at least one symbol among symbols in a slot configured to be DL by the BS for the UE or in a slot for repeated UL data channel transmission configured for the UE is configured to be DL, the UE may skip UL data channel transmission in the corresponding slot. For example, the UE may not transmit the UL data channel within the number of repeated UL data channel transmissions. In contrast, the UE supporting technical specification release 17 (Rel-17) repeated UL data transmission may determine that a slot capable of performing repeated UL data transmission is an available slot and may count the number of transmissions during repeated UL data channel transmission in the slot determined to be an available slot. When the repeated UL data channel transmission in a slot determined to be an available slot is skipped, the UE may perform repeated transmission via a slot available for transmission after postponing. By using Table 13 below, a redundancy version (RV) may be applied according to an RV pattern configured for each nth PUSCH transmission occasion.

### PUSCH Repeated Transmission Type B

As described above, within one slot, by a TDRA method, a start symbol and a length of a UL data channel may be determined, and the BS may transmit the number of repeated transmissions, numberofrepetitions, to the UE via higher layer signaling (e.g., RRC signaling) or L1 signaling (e.g., DCI). To determine the TBS, the number N of the slots configured as to numberOfSlotsTBoMS may be 1.

Based on the configured start symbol and length of the UL data channel, nominal repetition of the UL data channel may be determined as follows. The nominal repetition may refer to a resource of a symbol configured by the BS for repeated PUSCH transmission. The UE may determine a resource available for UL in the configured nominal repetition. In this case, a slot in which an nth nominal repetition starts may be given by

$${K}_{S} + ⌊ \frac{S + n * L}{{N}_{symb}^{slot}} ⌋ ,$$

and a symbol where a nominal repetition starts in the start slot may be given by

$$mod ( S + n * L , {N}_{s y m b}^{slot} ) .$$

A slot in which the nth nominal repetition ends may be given by

$${K}_{S} + ⌊ \frac{S + ( n + 1 ) * L - 1}{{N}_{symb}^{slot}} ⌋ ,$$

and a symbol where a nominal repetition ends in the last slot may be given by

$$mod ( S + ( n + 1 ) * L - 1 , {N}_{s y m b}^{slot} ) ,$$

where n=0, . . . , numberofrepetitions−1, S may denote the configured start symbol of the UL data channel, and L may indicate the configured symbol length of the UL data channel. K_{S} may indicate a slot in which the PUSCH transmission starts, and

$${N}_{s y m b}^{slot}$$

may indicate the number of symbols per slot.

The UE may determine an invalid symbol for PUSCH repeated transmission type B. A symbol configured for a DL by tdd-UL-DL-ConfigurationCommon or tdd-UL-DL-ConfigurationDedicated may be determined to be an invalid symbol for PUSCH repeated transmission type B. Additionally, an invalid symbol may be configured based on a higher layer parameter (e.g., InvalidSymbolPattern). As an example, when a higher layer parameter (e.g., InvalidSymbolPattern) provides a symbol-level bitmap in one slot or over two slots, an invalid symbol may be configured. The “1” that is indicated in a bitmap may represent an invalid symbol. Additionally, a period and a pattern of the bitmap may be configured via a higher layer parameter (e.g., periodicityAndPattern). If the higher layer parameter (e.g., InvalidSymbolPattern) is configured, and InvalidSymbolPatternIndicator-ForDCIFormat0_1 or InvalidSymbolPatternIndicator-ForDCIFormat0_2 parameter indicates 1, the UE may apply an invalid symbol pattern and, if the parameter indicates 0, the UE may not apply the invalid symbol pattern. Alternatively, if the higher layer parameter (e.g., InvalidSymbolPattern) is configured, and InvalidSymbolPatternIndicator-ForDCIFormat0_1 or InvalidSymbolPatternIndicator-ForDCIFormat0_2 parameter is not configured, the UE may apply the invalid symbol pattern.

After invalid symbols are determined in respective nominal repetitions, the UE may consider symbols other than the determined invalid symbol as valid symbols. If respective nominal repetitions include one or more valid symbols, the nominal repetitions may include one or more actual repetitions, which indicate symbols actually used for PUSCH repeated transmission from among symbols configured to be the configured nominal repetition, and may include a consecutive set of valid symbols available for PUSCH repeated transmission type B in one slot. When an actual repetition having one symbol is configured to be valid, except the case in which the configured symbol length L of the UL data channel is 1 (L=1), the UE may skip actual repetition transmission. By using Table 13 below, an RV may be applied according to an RV pattern configured for each nth actual repetition.

### TB Processing Over Multiple Slots (TBoMS)

As described above, within one slot, by using a TDRA method, a start symbol and a length of a UL data channel may be determined, and the BS may transmit the number of repeated transmissions to the UE via higher layer signaling (e.g., RRC signaling) or L1 signaling (e.g., DCI). A TBS may be determined using an N value greater than or equal to 1, which is the number of slots configured via numberOfSlotsTBoMS.

The UE may transmit a UL data channel, which has the same start symbol and length as the configured UL data channel above, in consecutive slots, based on the number of repeated transmissions and the number of slots for determining the TBS received from the BS. When at least one symbol among symbols in a slot for repeated UL data channel transmission configured for the UE or a slot configured to be DL by the BS for the UE is configured to be DL, the UE may skip UL data channel transmission in the corresponding slot. For example, although the UL data channel is included in the number of repeated UL data channel transmissions, the UE may not transmit the UL data channel.

On the other hand, the UE supporting Rel-17 repeated UL data transmission may determine that a slot capable of performing repeated UL data transmission is an available slot and may count the number of transmissions during repeated UL data channel transmission in the slot determined to be an available slot. When repeated UL data channel transmission in a slot determined to be an available slot is skipped, the UE may perform repeated transmission via a slot available for transmission after postponing. By using Table 13 below, an RV may be applied according to an RV pattern configured for each nth PUSCH transmission occasion.

TABLE 13

| | rv_{id} to be applied to n^{th} transmission occasion (repetition | | | |
|---|---|---|---|---|
| | Type A or TB processing over multiple slots) or n^{th} actual | | | |
| rv_{id} indicated | repetition (repetition Type B) | | | |
| by the DCI | ((n − (n mod | ((n − (n mod | ((n − (n mod | ((n − (n mod |
| scheduling | N))/N) | N))/N) | N))/N) | N))/N) |
| the PUSCH | mod 4 = 0 | mod 4 = 0 | mod 4 = 0 | mod 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Herein, if AvailableSlotCounting is configured to be enabled for the UE, the UE may determine an available slot for type A PUSCH repeated transmission and TBoMS PUSCH transmission, based on tdd-UL-DL-ConfigurationCommon, tdd-UL-DL-ConfigurationDedicated, ssb-PositionsInBurst, and a TDRA information field value. In other words, when, in a slot for PUSCH transmission, at least one symbol configured via TDRA for PUSCH overlaps at least one symbol having a purpose other than UL transmission, the slot may be determined to be an unavailable slot.

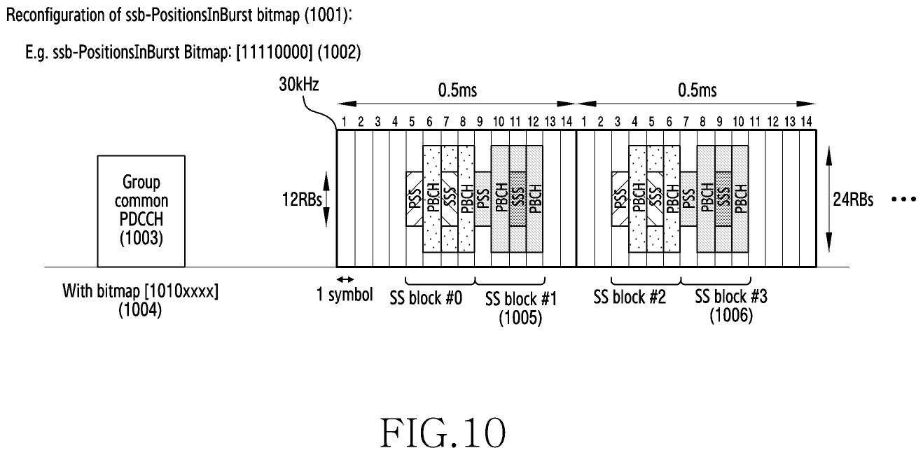

FIG. 10 illustrates a method of reconfiguring SSB transmission via dynamic signaling of a wireless communication system according to an embodiment.

Referring to FIG. 10, a UE may be configured with ssb-PositionsInBurst=“11110000” 1002 from a BS via higher layer signaling (SIB1 or ServingCellConfigCommon). A maximum of two SSBs at an SCS of 30 kHz may be transmitted within 0.5 ms (or corresponding to a length of one slot when one slot includes 14 OFDM symbols), and accordingly, the UE may receive four SSBs within 1 ms (or corresponding to a length of two slots when one slot includes 14 OFDM symbols). In this case, to reduce SSB transmission density to save energy, the BS may broadcast a bitmap ‘1010xxxx’ 1004 via group common DCI 1003 having a network energy saving-radio network temporary identifier) (nwes-RNTI) (or es-RNTI), thereby reconfiguring SSB transmission configuration information. In this case, transmission of SS block #1 1005 and SS block #3 1006 may be canceled based on a bitmap 1004 configured via Group/Cell common DCI. Referring to FIG. 10, a method is provided in which SSB transmission via bitmap-based group/cell common DCI (indicated by reference numeral 1001) is reconfigured.

In addition, via the group/cell common DCI, the BS may reconfigure ssb-periodicity configured via higher layer signaling. By additionally configuring timer information for indication of a time point to apply the group/cell common DCI, SSB transmission may be performed according to SSB transmission information reconfigured through the group/cell common DCI during the configured timer. Thereafter, when the timer expires, the BS may operate according to the SSB transmission information configured via existing higher layer signaling. Accordingly, the BS may change a configuration from a normal mode to an energy saving mode via the timer and may reconfigure SSB configuration information resulting from the changed configuration. As another method, the BS may configure, as offset and duration information for the UE, a period and a time point to apply the SSB configuration information reconfigured via the group/cell common DCI. In this case, the UE may not monitor the SSB for a duration from the moment of receiving the group/cell common DCI to a time point of applying the offset.

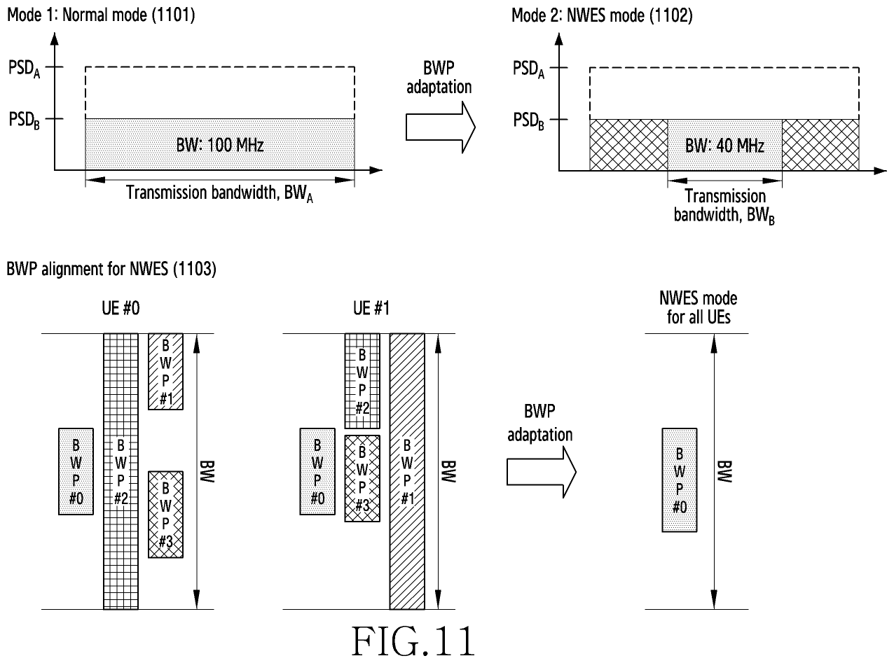

FIG. 11 illustrates a method of reconfiguring a BWP and a BW via dynamic signaling of a wireless communication system according to an embodiment.

Referring to FIG. 11, a UE may operate using a BWP or BW activated via higher layer signaling and L1 signaling from a BS (indicated by reference numeral 1101). For example, the UE may operate via a full BW of 100 MHz with a fixed power PSDB. In this case, for energy saving, the BS may adjust the BW and BWP to activate, for the UE, a narrower BW of 40 MHz with the same power PSDB (indicated by reference numeral 1102). Adjusting the BW or BWP for energy saving by the BS may be performed to equally match the UE-specifically configured BWP and BW via group common DCI and cell-specific DCI (indicated by reference numeral 1103). For example, UE #0 and UE #1 may have different BWP configurations and positions. In this case, for the BS to save energy by reducing BWs used, BWs and BWPs of all UEs may be configured equally to one. In this case, one or more BWPs or BWs in the operation for energy saving may be configured, which may be used to configure a UE group-specific BWP.

Herein, upper layer signaling may refer to signaling corresponding to at least one signaling among the following signaling, or a combination of MIB,

$$SIB or SIB X ( X = 1 , 2 , … ) ,$$

RRC, or medium access control (MAC) control element (CE).

L1 signaling may correspond to at least one signaling method among signaling methods using the following physical layer channels or signaling, or a combination of one or more thereof.
PDCCH
DCI
UE-specific DCI
Group common DCI
Common DCI
Scheduling DCI (for example, DCI used for scheduling DL or UL data)
Non-scheduling DCI (for example, DCI not used for scheduling DL or UL data)
Physical UL control channel (PUCCH)
UL control information (UCI)

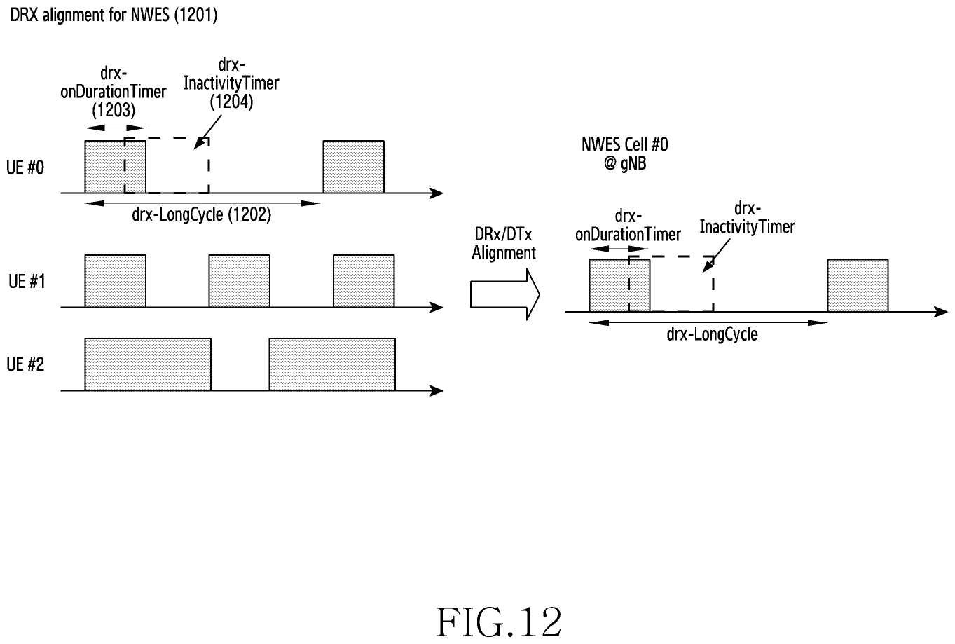

FIG. 12 illustrates a method of reconfiguring DRX via dynamic signaling of a wireless communication system according to an embodiment.

Referring to FIG. 12, a BS may UE-specifically configure DRX via higher layer signaling. For example, different drx-LongCycle 1202, drx-ShortCycle, drx-onDurationTimer 1203, and drx-InactivityTimer 1204 may be configured for each UE. Thereafter, for energy saving, the BS may configure the UE-specific DRX configuration to be UE group-specific or cell-specific via L1 signaling (indicated by reference numeral 1201). Accordingly, the BS may achieve, for energy saving, the same effect as that of power saving via DRX by the UE.

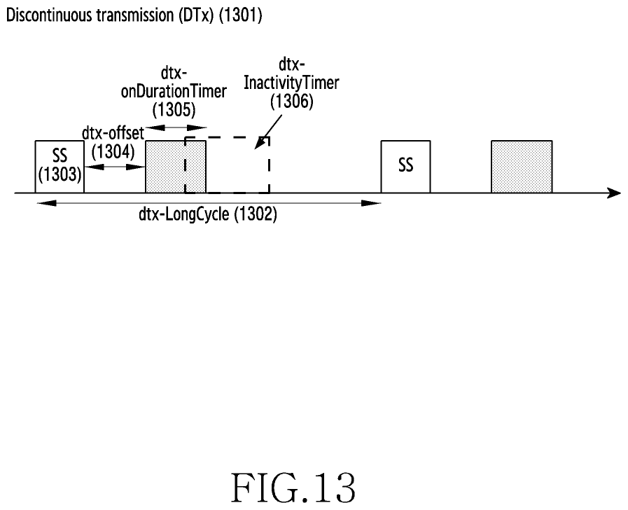

FIG. 13 illustrates a DTx method for BS energy saving according to an embodiment.

Referring to FIG. 13, a BS may configure DTx for energy saving via higher layer signaling (e.g., new SIB for DTx or RRC signaling) and L1 signaling (e.g., DCI). In this case, the BS may configure dtx-onDurationTimer 1305 for transmitting a PDCCH for scheduling of a DL SCH for DTx 1301 operation or a reference signal for measurement for RRM measurement, beam management, pathloss, etc., an SS 1303 configuration information for synchronization before dtx-onDurationTimer and dtx-InactivityTimer 1306 for receiving a PDSCH after reception of the PDCCH for scheduling of the DL SCH, dtx-offset 1304 for configuring an offset between dtx-onDurationTimer after the SS, and dtx-(Long) Cycle 1302 for DTx to operate periodically based on the configuration information. In this case, dtx-cycle may include a long cycle and a short cycle, and a plurality of dtx-cycle may be configured. During the DTx operation, the BS may consider a transmission node to be off (or inactive) and therefore, the BS may not transmit DL control channel (CCH), shared channel (SCH), and DL RS. That is, during the DTx 1301 operation, the BS may transmit DL (e.g., PDCCH, PDSCH, RS, and the like) only during SS, dtx-onDurationTimer, and dtx-InactivityTimer. In this case, SS-gapbetweenBurst (gap between SS bursts in time domain) or the number of SS bursts may be additionally configured as additional information of the configured SS.

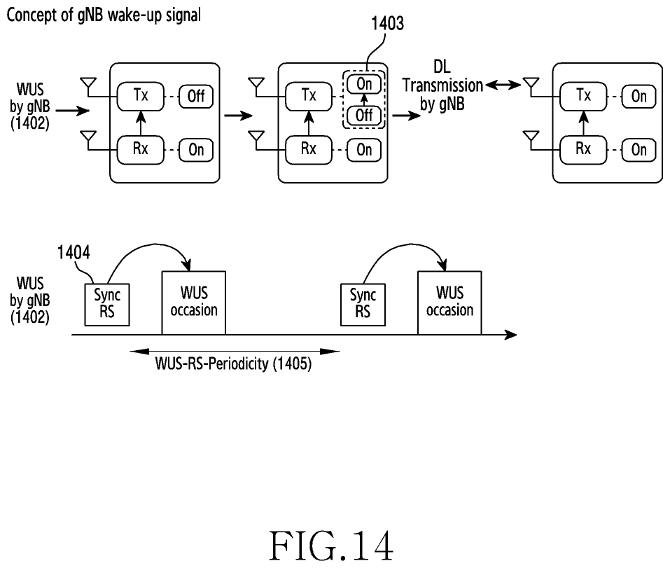

FIG. 14 illustrates a BS operation according to a gNB WUS according to an embodiment.

Referring to FIG. 14, a BS may maintain a transmitter node in an off (or inactive) state while the BS is in an inactive state (or sleep mode) to save energy. The BS may then receive a gNB WUS 1402 from a UE to activate the sleep mode of the BS. Thereafter, the BS may change the Tx node to be an on (or active) state when receiving the WUS from the UE via an Rx node (indicated by reference numeral 1403). The BS may then perform DL transmission to the UE. In this case, the BS may perform synchronization after Tx on, and perform control channel and data channel transmission. In addition, various UL signals, for example, a PRACH, a scheduling request (SR PUCCH), a PUCCH including ACK, and the like, may be considered as the gNB WUS. Via the method above, the BS may perform energy saving, and at the same time, the UE may improve latency.

In this case, the BS may configure a WUS occasion for receiving a gNB WUS, and a Sync RS for synchronization before the UE transmits a gNB WUS. In this case, an SSB, a tracking reference signal (TRS), a light SSB (PSS and SSS), consecutive SSBs, or a new RS (e.g., continuous PSS and SSS) may be considered as the Sync RS, and a PRACH, a PUCCH with SR, or a sequence-based signal may be considered as the WUS. A Sync RS 1404 for the UE to activate a deactivation mode for energy saving of the BS, and a WUS occasion for receiving a WUS may be repeatedly transmitted in a WUS-RS periodicity 1405. Referring to FIG. 14, 1-to-1 mapping of the Sync RS and the WUS occasion is described, but the disclosed is not limited thereto, and the Sync RS and the WUS occasion may be N-to-1 mapped, 1-to-N mapped, or N-to-M mapped.

Hereinafter, a description will be provided for a method of dynamically turning on/off spatial domain (SD) elements (i.e., antenna, power amplifier (PA), or transceiver units or transmission radio units (TxRUs)) of a BS to save BS energy in the 5G system.

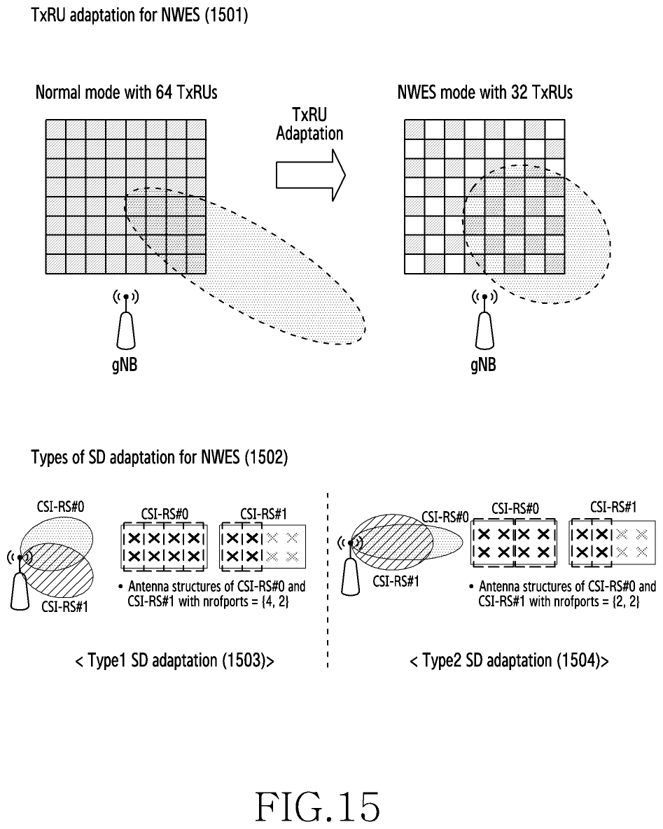

FIG. 15 illustrates an antenna adaptation method of a BS to save energy in a wireless communication system according to an embodiment.

Referring to FIG. 15, a BS may adjust a Tx antenna port per radio unit (RU) for energy saving (network energy savings (NWES) or NES) (indicated by reference numeral 1501). For example, since energy consumed in a PA of the BS accounts for most of energy consumption of the BS, the BS may turn off a Tx antenna to save energy. In this case, to determine whether the Tx antenna may be turned off, the BS may refer/use the reference signal received power (RSRP), channel quality indicator (CQI), reference signal received quality (RSRQ), etc., of a UE. The BS may perform Tx transmission by adjusting the number of activated Tx antennas for each UE group or UE. In this case, the BS may configure, for the UE, beam information according to on/off of the antenna or information including at least one reference signal information (e.g., at least one of a CSI resource, a CSI-RS resource set, or a CSI report) via higher layer signaling (RRC signaling) or DCI signaling. The BS may configure different antenna information for each BWP, and thus may reconfigure the antenna information according to a BWP change. The BS may receive CSI feedback from the UE to determine whether SD adaptation is possible. The BS may, (based on the CSI feedback), determine SD adaptation. The BS may receive, from the UE, multiple feedbacks via antenna structure hypotheses of various antenna patterns for SD adaptation.

More specifically, the BS may apply multiple types (e.g., two types) of SD adaptation for energy saving (indicated by reference numeral 1502). For example, the multiple types may include Type 1 SD adaptation 1503 and Type 2 SD adaptation 1504.

When Type 1 SD adaptation 1503 is applied, the BS may adapt the number of antenna ports while maintaining the number of physical antenna elements for each antenna port (i.e., a logical port). In this case, RF characteristics (e.g., tx power and beam) per port may be the same. Therefore, the UE may perform measurement by combining CSI-RSs of the same port during CSI measurement (e.g., layer 1 (L1)-RSRP, layer 3 (L3)-RSRP, and the like).

Alternatively, when Type 2 SD adaptation 1504 is applied, the BS may turn on/off a physical antenna element for each port by maintaining the same number of antenna ports (i.e., logical ports) (1504). In this case, the RF characteristics per port may differ. The UE may perform measurements by distinguishing CSI-RSs of the same port during CSI measurement. The BS may save energy by using one or more of multiple types of SD adaptation methods including the two types of SD adaptation methods mentioned above.

Herein, on-demand operation may refer to including on-demand SSB and on-demand SIB (e.g., on-demand SIB1). While embodiments are described below with an emphasis on on-demand SIB1, the disclosure is also applicable to on-demand SSB and another SIB (on-demand SIB). Unless specifically mentioned otherwise, a request for SIB1 may be made through or by a WUS that may be transmitted by a UE having the capability to receive on-demand SIB1, and the corresponding WUS may be considered to be a WUS received by a BS capable of transmitting on-demand SIB1 so that the BS may understand that the UE is requesting SIB1.

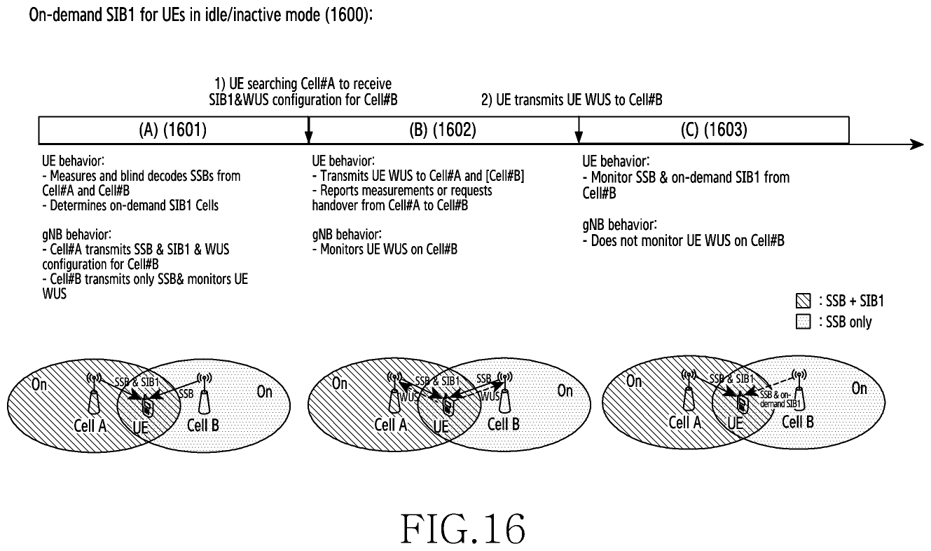

FIG. 16 illustrates an example of on-demand SIB1 operation of a BS and a UE considering multiple cells according to an embodiment.

A BS may apply/configure/operate multiple cells with different functions for on-demand SIB1 operation considering multiple cells. For example, the BS may apply/configure/operate two different cells with different functions for on-demand SIB1 operation considering multiple cells.

For example, the BS may periodically transmit additional information (e.g., WUS configuration, SIB information of additional neighboring cells) to (or from) the anchor (or reference, adjacent, neighbor) cell for the on-demand SIB1 operation of neighboring cells, and may provide the UE with information of cells that do not transmit SIB1 during the on-demand SIB1 operation (cells that do not transmit SIB1, cells that do not perform SIB1 transmission). A cell that does not transmit SIB1 during the on-demand SIB1 operation may be an on-demand SIB1 cell or may include an on-demand SIB1 cell.

The BS may apply/configure/operate an on-demand SIB1 cell. The on-demand SIB1 cell is a cell that does not transmit SIB1 to save energy. For example, whether to transmit SIB1 of an on-demand SIB1 cell may be based on the request of the UE (i.e., on-demand), and the on-demand SIB1 cell does not transmit SIB1 when there is no request from the UE, and transmits SIB1 when requested by the UE. The on-demand SIB1 cell is always transmitting SSB (i.e., regardless of the UE's request) and may monitor WUS according to its configuration. Whether the BS monitors WUS may be configured in the UE through the anchor cell via higher layer signaling. In addition, when the BS does not (directly) receive the WUS from the on-demand SIB1 cell, the BS may receive the SIB1 request from the anchor cell (or forward the SIB1 request to the on-demand SIB1 cell) via backhaul signaling. The on-demand SIB1 operation may be performed using the above two cells. In this case, the anchor cell may support one or multiple on-demand SIB1 cells and may have greater coverage than the on-demand SIB1 cells.

Referring to FIG. 16, the BS may apply on-demand SIB1 operation to save energy. More specifically, referring to section (A) 1601, the BS may perform on-demand SIB1 operation using multiple cells (an anchor cell (Cell A) and an on-demand SIB1 cell (Cell B)). In this case, the BS may transmit, via the anchor cell (Cell A), the SSB and SIB1 of the corresponding cell and additionally transmit the WUS configuration (resource configuration and power control information for WUS transmission) and some SIB1 information (some of the information included in the SIB1 of the on-demand SIB1 cell, for example, information related to Access (e.g., AccessCellInfo or Barring information)) to request the SIB1 of the on-demand SIB1 cell. Alternatively, the BS may transmit SSB from the on-demand SIB1 cell (Cell B) and monitor the WUS according to the WUS configuration. The UE may measure the SSB from Cell A and Cell B and decide whether to request SIB1 from Cell B when packet processing is required.

As a method in which a UE distinguishes between an anchor cell and an on-demand SIB1 cell, one of the following methods or one or more combinations thereof may be employed (B).

### Method 3

The UE may determine the anchor cell or the on-demand SIB1 cell through the PSS, SSS, and/or physical cell identity (PCI) of the SSB. More specifically, the PCI

$${N}_{ID}^{c e l l}$$

is determined as shown in Equation (2) below.

$${N}_{I D}^{cell} = 3 {N}_{I D}^{( 1 )} + {N}_{I D}^{( 2 )} {N}_{I D}^{( 1 )} ∈ ( 0 , 1 , … , 335 \} , {N}_{I D}^{( 2 )} ∈ \{ 0 , 1 , 2 \} \qquad ( 2 )$$

In Equation (2), the ranges of

$${N}_{ID}^{( 1 )} and {N}_{ID}^{( 2 )}$$

are examples, and the range of possible values for

$${N}_{ID}^{( 1 )} and {N}_{ID}^{( 2 )}$$

is not limited thereto.

$${N}_{ID}^{c e l l}$$

may be 0, . . . , 1007, but this is an example and the range of possible values for

$${N}_{ID}^{cell}$$

is not limited thereto.

In case that cell IDs

$${N}_{ID}^{( 2 )}$$

of the PSS and/or cell group ID

$${N}_{ID}^{( 1 )}$$

of the SSS are configured as a pre-configured or determined values, the UE may determine that the corresponding cell is the anchor cell or on-demand SIB1 cell. For example, at least some of the possible values for

$${N}_{ID}^{( 2 )}$$

and/or at least some of the possible values for

$${N}_{ID}^{( 1 )}$$

may be configured/determined to indicate this as an anchor cell. In addition/alternatively, at least some of the possible values for

$${N}_{ID}^{( 2 )}$$

and/or at least some for the possible values of

$${N}_{ID}^{( 1 )}$$

may be configured/determined to indicate that it is an on-demand SIB1 cell.

Alternatively, in case that the PCI determined through the PSS and SSS is configured as a specific pre-configured or determined value, the UE may determine that the corresponding cell is the anchor cell or on-demand SIB1 cell. For example, at least some of the possible values for

$${N}_{ID}^{cell}$$

of may be configured/determined to indicate that it is the anchor cell. For example, at least some of the possible values for

$${N}_{ID}^{cell}$$

may be configured/determined to indicate that it is the on-demand SIB1 cell.

### Method 4

The UE may determine that the cell is an anchor cell or an on-demand SIB1 cell by using information of the MIB through the PBCH of the SSB. More specifically, the UE may determine the anchor cell or on-demand SIB1 cell by using at least some of the information of the MIB shown in Table 14 below.

```
TABLE 14
MIB ::= SEQUENCE {
  systemFrameNumber BIT STRING (SIZE (6)),
  subCarrierSpacingCommon ENUMERATED {scs15or60, scs30or120},
  ssb-SubcarrierOffset INTEGER (0..15),
  dmrs-TypeA-Position ENUMERATED {pos2, pos3},
  pdcch-ConfigSIB1,
  cellBarred ENUMERATED {barred, notBarred},
  intraFreqReselection ENUMERATED {allowed, notAllowed},
  spare BIT STRING (SIZE (1))
}
```

For example, the spare information may be used. When the spare information is configured as “0”, the cell corresponding to the corresponding MIB may be determined to be an anchor cell, and when the spare information is configured as “1”, the cell corresponding to the corresponding MIB may be determined to be an on-demand SIB1 cell. Conversely, when the spare information is configured as “1”, the cell corresponding to the corresponding MIB may be determined to be an anchor cell, and when the spare information is configured as “0”, the cell corresponding to the corresponding MIB may be determined to be an on-demand SIB1 cell.

Alternatively, the ssb-SubcarrierOffset and/or pdcch-ConfigSIB1 information of the MIB may be utilized. In this case, the ssb-SubcarrierOffset and/or pdcch-ConfigSIB1 information of the MIB may be interpreted and used differently from the conventional information. In addition and/or alternatively, a specific most significant bit (MSB) or LSB may indicate whether the cell is an on-demand SIB1 cell.

For example, the MSB or LSB of ssb-SubcarrierOffset and/or pdcch-ConfigSIB1 may indicate whether the cell corresponding to the MIB is an on-demand SIB1 cell. The ssb-SubcarrierOffset and/or pdcch-ConfigSIB1 are examples, and information elements (IEs) in other MIBs may be used. The MSB or LSB of an IE in a specific MIB may indicate whether the cell corresponding to the MIB is an on-demand SIB1 cell. For example, when the MSB or LSB has a predefined/configured value, the cell corresponding to the corresponding MIB may be determined to be an on-demand SIB1 cell.

Alternatively, a combination of the cellBarred information and spare information may be used. When the cellBarred information is barred and the spare information is configured as “1”, the cell corresponding to the corresponding MIB may be determined to be an on-demand SIB1 cell. When the cellBarred information is notBarred and the spare information is configured as “1”, the cell corresponding to the corresponding MIB may be determined to be an anchor cell.

### Method 5

The UE may determine an on-demand SIB1 cell, based on whether SIB1 is transmitted from the corresponding cell during a specific time period. In other words, based on whether the SIB1 has been received from a specific cell during a specific period of time, it may be determined whether the corresponding specific cell is an on-demand SIB1 cell.

More specifically, the UE may receive in advance a configuration of a window for monitoring SIB1. The UE may determine that the at least one cell corresponding to the corresponding SIB1 is an on-demand SIB1 cell when no SIB1 is received during the corresponding time period. For example, the UE may determine that the at least one cell corresponding to the SIB1 is an on-demand SIB1 cell when a PDSCH for the SIB1 is not received during the corresponding period of time.

The UE may determine an on-demand SIB1 cell, based on the number of search space monitoring iterations (e.g., the number of times the UE has performed monitoring for the search space (within the window)) for receiving a PDCCH (e.g., a PDCCH addressed by a system information radio network temporary identifier (SI-RNTI)) for SIB1 scheduling (i.e., containing scheduling information of the SIB1). For example, when the number of search space monitoring iterations is greater than or equal to a preconfigured/predefined threshold, the cell may be determined to be an on-demand SIB1 cell.

In this case, the measurement taken by the UE from the SSB of the corresponding cell should satisfy the requirement for radio resource management (RRM) measurement, which may be necessary to access the corresponding cell. In other words, when a specific cell satisfies the requirement but no SIB1 is received from the specific cell, the specific cell may be determined to be an on-demand SIB1 cell, such as when the RSRP and/or RSRQ measured from the SSB of the specific cell satisfies the RRM requirement, but no SIB1 is received from the specific cell.

By using at least one of the above methods, the UE may determine whether the corresponding cell is an on-demand SIB1 cell or an anchor cell.

Thereafter, in section (B) 1602, the UE may, via the anchor cell, receive configuration information for WUS transmission via higher layer signaling (e.g., RRC, SIB1, or SIB for NES) or L1 signaling (message 4 (MSG4) or PUSCH/PUCH) and information for accessing the corresponding on-demand SIB1 cell, and may request the SIB1 to access the on-demand SIB1 cell.

In this case, the UE may determine to access the on-demand SIB1 cell rather than the anchor cell when the differences between the RSRPs and RSRQs measured from the SSBs of the anchor cell and the on-demand SIB1 cell, respectively are greater than a specific threshold. For example, when the difference between the RSRP or RSRQ measured from the SSB of the on-demand SIB1 cell and the RSRP or RSRQ measured from the SSB of the anchor cell is greater than or equal to a predefined/configured threshold, the UE may determine to access the on-demand SIB1 cell. In addition, the UE may report the measurement result to the anchor cell or request a handover, thereby indicating a request for the on-demand SIB1 cell via the anchor cell. When the anchor cell receives reporting of the measurement result of the UE and/or a handover request from the anchor cell to the on-demand SIB1 cell, the anchor cell may indicate the on-demand SIB1 request to the on-demand SIB1 cell. The anchor cell may indicate, to the on-demand SIB1 cell via backhaul signaling, the measurement result from the UE and/or whether to request the on-demand SIB1 request.

When access to the anchor cell is identified as being impossible according to the cellBarred information of the MIB of the anchor cell, the UE may determine to access the on-demand SIB1 cell.

Thereafter, in section (B) 1602, the UE may transmit the WUS to the anchor cell or the on-demand SIB1 cell according to the WUS configuration information. For example, the WUS may be transmitted via PUCH, PRACH, or PUSCH.

The UE may transmit the WUS once or multiple times in section (C) 1603. After transmitting the WUS, the UE may monitor the PDCCH for SIB1 scheduling from the on-demand SIB1 cell. When the UE has identified the on-demand SIB1 cell in the previous section (B) 1602, the UE may not monitor the PDCCH related to SIB1 (from the on-demand SIB1 cell) until the WUS is transmitted. In this case, the BS may transmit the SIB1 without monitoring the WUS after receiving the WUS. In other words, the BS may stop monitoring the WUS after receiving the WUS and transmit the SIB1 of the on-demand SIB1 cell.

ABS and a UE may perform an on-demand SIB1 operation considering multiple cells by using at least some of the above methods.

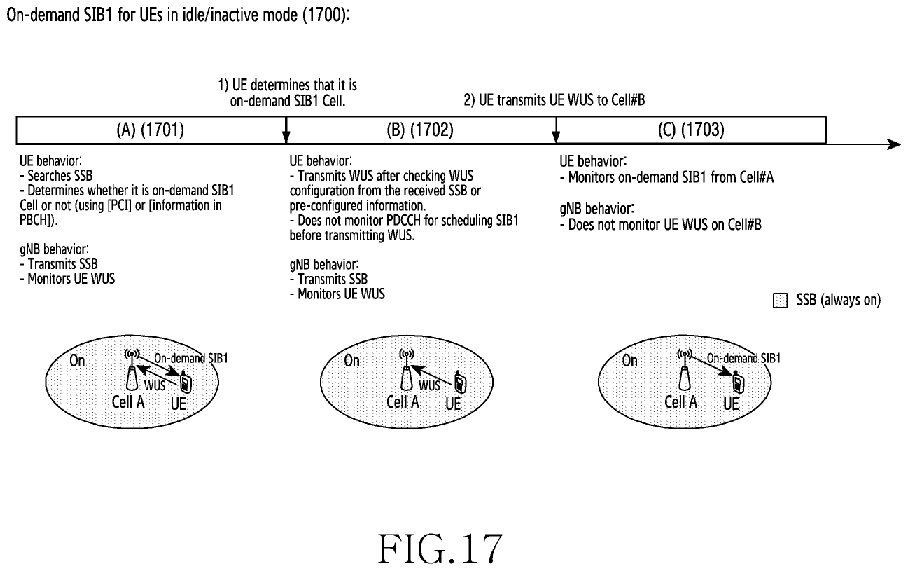

FIG. 17 illustrates an example of on-demand SIB1 operation 1700 of a BS and a UE considering a single cell according to an embodiment.

Referring to FIG. 17, the BS may perform on-demand SIB1 operation considering a single cell. In this case, the corresponding cell periodically transmits an SSB and may or may not periodically transmit a PDCCH for SIB1 and a PDSCH for SIB1 (A) 1701. For example, whether the cell has transmitted SIB1 may be based on a request from the UE, and the cell may not transmit SIB1 in the absence of a request from the UE, and may transmit SIB1 in the presence of a request from the UE. In addition, the cell may monitor the WUS to receive the on-demand request of SIB1. The UE may receive the SSB through the cell, and then may determine whether to perform the on-demand SIB1 operation by using one or a combination of one or more of the following methods. That is, the UE may determine whether the cell is an on-demand SIB1 cell supporting on-demand SIB1, using one or a combination of one or more of the following methods.

### Method 6

The UE may determine the on-demand SIB1 cell through the PSS, SSS, or PCI of the SSB. More specifically, PCI

$${N}_{ID}^{cell}$$

is determined as shown in Equation (3) below.

$${N}_{ID}^{cell} = 3 {N}_{ID}^{( 1 )} + {N}_{ID}^{( 2 )} {N}_{ID}^{( 1 )} ∈ \{ 0 , 1 , … , 335 \} , {N}_{ID}^{( 2 )} ∈ \{ 0 , 1 , 2 \} \qquad ( 3 )$$

In Equation (3), the ranges of

$${N}_{ID}^{( 1 )} and {N}_{ID}^{( 2 )}$$

are examples, and the range of possible values for

$${N}_{ID}^{( 1 )} and {N}_{ID}^{( 2 )}$$

in the disclosure is not limited thereto.

$${N}_{ID}^{c e l l}$$

may be 0, . . . , 1007, but this is an example and the range of possible values for

$${N}_{ID}^{cell}$$

is not limited thereto.

When cell IDs

$${N}_{ID}^{( 2 )}$$

of the PSS and/or cell group ID

$${N}_{ID}^{( 1 )}$$

of the SSS are configured as pre-configured or determined values, the UE may determine that the corresponding cell is an on-demand SIB1 cell. For example, at least some of the possible values tor

$${N}_{ID}^{( 2 )} and / or {N}_{ID}^{( 1 )}$$

may be configured/determined to indicate that it is the on-demand SIB1 cell.

When the PCI determined through the PSS and SSS is configured as a specific pre-configured or determined value, the UE may determine that the corresponding cell is the on-demand SIB1 cell. For example, at least some of the possible values for

$${N}_{ID}^{cell}$$

of may be configured/determined to indicate that it is the on-demand SIB1 cell.

### Method 7

The UE may determine that the cell is an on-demand SIB1 cell by using information of the MIB through the PBCH of the SSB. More specifically, the UE may determine the on-demand SIB1 cell using at least some of the information of the MIB shown in Table 15 below.

```
TABLE 15
MIB ::= SEQUENCE {
  systemFrameNumber BIT STRING (SIZE (6)),
  subCarrierSpacingCommon ENUMERATED {scs15or60, scs30or120},
  ssb-SubcarrierOffset INTEGER (0..15),
  dmrs-TypeA-Position ENUMERATED {pos2, pos3},
  pdcch-ConfigSIB1,
  cellBarred ENUMERATED {barred, notBarred},
  intraFreqReselection ENUMERATED {allowed, notAllowed},
  spare BIT STRING (SIZE (1))
}
```

For example, when the spare information may be configured as “0”, the on-demand SIB1 operation for the cell corresponding to the corresponding MIB may be determined to be deactivated, and when configured as “1”, the cell corresponding to the corresponding MIB may be determined to be an on-demand SIB1 cell. Conversely, when the spare information is configured as “1”, the on-demand SIB1 operation for the cell corresponding to the corresponding MIB may be determined to be deactivated, and when the spare information is configured as “0”, the cell corresponding to the corresponding MIB may be determined to be an on-demand SIB1 cell.

In addition/alternatively, the ssb-SubcarrierOffset and/or pdcch-ConfigSIB1 information of the MIB may be utilized. In this case, the ssb-SubcarrierOffset and/or pdcch-ConfigSIB1 information of the MIB may be interpreted and used differently from the conventional information. For example, a specific MSB or LSB may indicate whether the cell is an on-demand SIB1 cell.

For example, the MSB or LSB of ssb-SubcarrierOffset and/or pdcch-ConfigSIB1 may indicate that the cell corresponding to the corresponding MIB is the on-demand SIB1 cell. The ssb-SubcarrierOffset and/or pdcch-ConfigSIB1 are examples, and IEs in other MIBs may be used. For example, the MSB or LSB of an IE within a specific MIB may indicate that the cell corresponding to the MIB is an on-demand SIB1 cell. Alternatively, when the MSB or LSB has a predefined/configured value, the cell corresponding to the corresponding MIB may be determined to be an on-demand SIB1 cell.

A combination of the cellBarred information and the spare information may also be used. When the cellBarred information is barred and the spare information is configured as “1”, the cell corresponding to the corresponding MIB may be determined to be a cell in which the on-demand SIB1 operation is activated. When the cellBarred information is barred and the spare information is configured as “0”, the cell corresponding to the corresponding MIB may be determined to be a cell in which the on-demand SIB1 operation is deactivated.

### Method 8

The UE may determine whether the corresponding cell is an on-demand SIB1 cell, based on whether the SIB1 is transmitted from the corresponding cell during a specific time period. In other words, based on whether the SIB1 has been received from a specific cell during a specific time period, it is decided/determined whether the specific cell is an on-demand SIB1 cell.

More specifically, the UE may receive in advance a configuration of a window for monitoring SIB1. The UE may determine that the at least one cell corresponding to the corresponding SIB1 is an on-demand SIB1 cell when no SIB1 is received during the corresponding time period. For example, the UE may determine that the at least one cell corresponding to the SIB1 is an on-demand SIB1 cell when a PDSCH for the SIB1 is not received during the corresponding time period.

The UE may determine an on-demand SIB1 cell, based on the number of iterations of search space monitoring (e.g., the number of iterations the UE has performed monitoring for the search space (within the window)) for receiving a PDCCH (e.g., a PDCCH addressed by an SI-RNTI for SIB1 scheduling (i.e., containing scheduling information of the SIB1). For example, when the number of search space monitoring iterations is greater than or equal to a preconfigured/predefined threshold, the cell may be determined to be an on-demand SIB1 cell.

In this case, the measurement taken by the UE from the SSB of the corresponding cell should satisfy the requirement for radio resource management (RRM) measurement to access the corresponding cell. In other words, a specific cell may be determined to be an on-demand SIB1 cell when the RSRP and/or RSRQ measured from the SSB of the specific cell satisfies the RRM requirement, but no SIB1 is received from the specific cell.

By using at least one of the above methods, the UE may determine whether the corresponding cell activates or deactivates the on-demand SIB1.

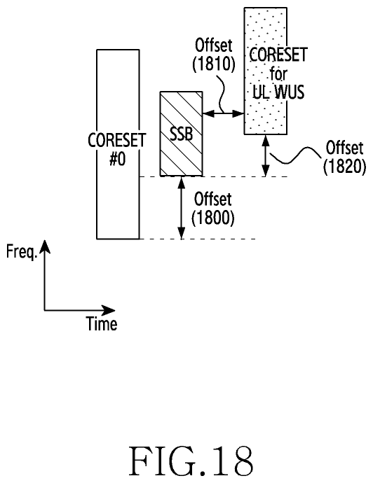

Thereafter, in section (B) 1702, the UE determines whether the on-demand SIB1 of the corresponding cell is activated. When it is activated, the UE may request the SIB1 by transmitting a WUS based on the pre-configured WUS resource information to transmit the WUS when access is required. A method by which the UE may determine the WUS resource information (WUS configuration) is described in detail with reference to FIGS. 18, 19, and 20 below.

In section (C) 1703, after performing the WUS transmission based on the configuration information of the UE, the UE may monitor the PDCCH for scheduling of SIB1 from the corresponding cell, and may initially access the corresponding cell after receiving the SIB1. The BS may not monitor the WUS from the corresponding cell after receiving the WUS. In other words, the BS may stop monitoring the WUS from the corresponding cell after receiving the WUS.

FIGS. 18, 19, and 20 describe methods for providing a UE with information (WUS configuration) required for the UE to transmit a WUS (or UL WUS). These methods may be applied to the on-demand SIB1 operation considering a single cell as described in FIG. 17, to provide resource information required to receive a PDCCH or PDSCH to receive the UL WUS configuration information required when the UE transmits a UL WUS to request an on-demand SIB in an on-demand SIB1 cell supporting on-demand SIB1.

### Method 9

FIG. 18 illustrates a first scheme for providing resource information required to receive UL WUS configuration information according to an embodiment. Referring to FIG. 18, the resource information required to receive the UL WUS configuration information is represented as a CORESET for UL WUS. The CORESET may be indicated by time and frequency offsets 1810 and 1800, respectively, from the SSB (or CD-SSB, cell defining-SSB) received from the on-demand SIB1 cell. Different time and frequency offsets may be defined in the standard specification depending on whether the frequency domain is FR1 or FR2, or on the SCS of the SSB received from the on-demand SIB1 cell.

The CORESET may be defined in the specification as having a time duration of K symbols or M PRBs. The K and M may be natural numbers greater than or equal to 1.

The UE may determine that the CORESET is QCLed to the SSB that serves as a reference for the time and frequency offset. Based on the QCL, the UE may receive the PDCCH or PDSCH required to receive UL WUS configuration information in the CORESET.

Since periodic SIB1 is not transmitted in the on-demand SIB1 cell, the UE may determine that CORESET #0, which is the PDCCH or PDSCH resource information required to receive the periodic SIB1, is not transmitted periodically, and the BS may save energy by not transmitting CORESET #0 periodically.

### Method 10

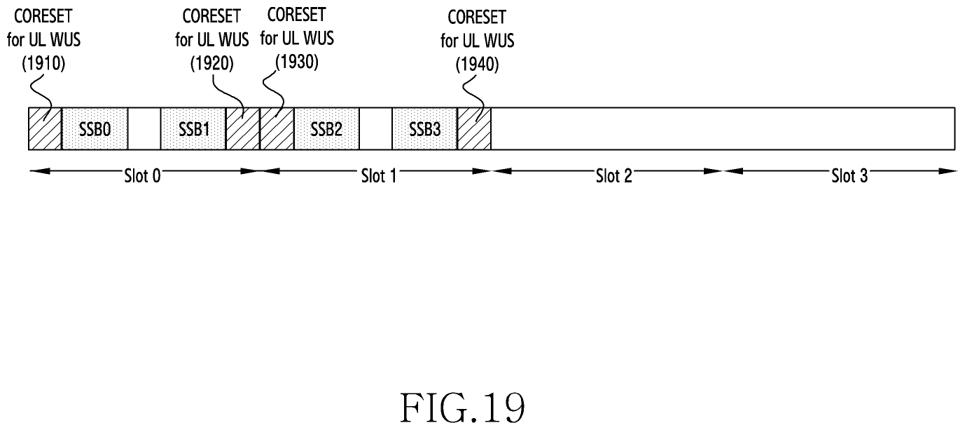

FIG. 19 illustrates a second scheme for providing the resource information required to receive UL WUS configuration information according to an embodiment. Referring to FIG. 19, the resource information required to receive the UL WUS configuration information is represented by the CORESETs for UL WUS, wherein the CORESETs 1910, 1920, 1930, and 1940 are defined to be transmitted in the on-demand SIB1 cell or may be defined in the specification as being transmitted in the symbol immediately preceding the SSB (or CD-SSB, cell defining-SSB) received by the UE or in the symbol immediately following the SSB (or CD-SSB, cell defining-SSB).

The SSBs in FIG. 19 are based on case #3 of FIG. 5 as an example, and the second method may be applied without limitation based on the various SSB resource cases described in embodiments herein.

The CORESET may be defined in the standard specification as having a time duration of K symbols or M PRBs. The K and M may be natural numbers greater than or equal to 1.

The UE may determine that the CORESET is QCLed to an immediately adjacent SSB. Based on the QCL, the UE may receive the PDCCH or PDSCH required to receive UL WUS configuration information in the CORESET.

Since periodic SIB1 is not transmitted in the on-demand SIB1 cell, the UE may determine that CORESET #0, which is the PDCCH or PDSCH resource information required to receive the periodic SIB1, is not transmitted periodically, and the BS may save energy by not transmitting CORESET #0 periodically. The BS may also transmit the CORESET and SSB for UL WUS consecutively and save energy in the remaining non-transmission time.

### Method 11

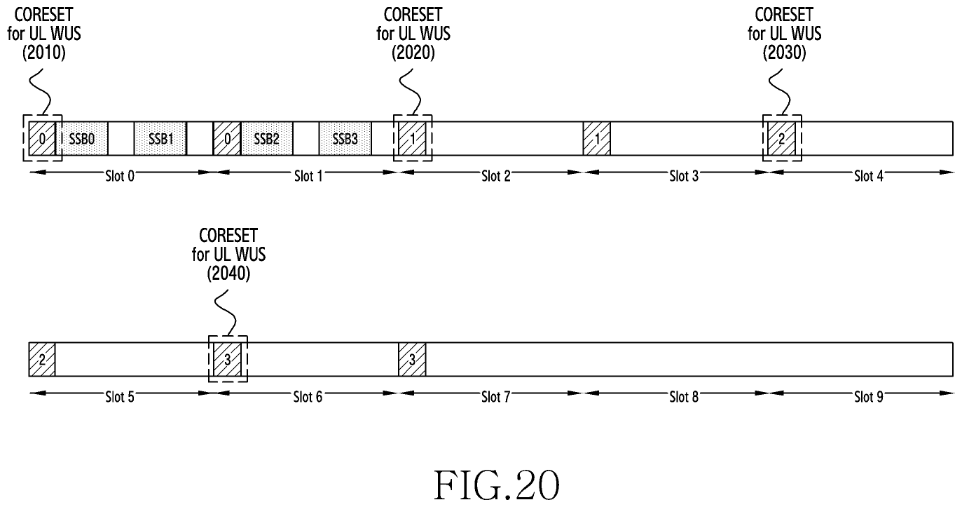

FIG. 20 illustrates a third scheme for providing the resource information required to receive UL WUS configuration information according to an embodiment. Referring to FIG. 20, the resource information required to receive the UL WUS configuration information is represented by CORESETs for UL WUS, where the CORESETs 2010, 2020, 2030, and 2040 may be CORESETs of some of the time-frequency resource configuration information of control region #0 and CORESET #0 as indicated by 8 bits (pdcch-ConfigSIB1) in the MIB.

FIG. 20 illustrates when a first CORESET #0 that is QCLed to each SSB among the CORESET #0s indicated by pdcch-ConfigSIB1 is defined in the specification as a CORESET for UL WUS, but it is also possible to define in the specification only CORESET #0 that is QCLed to a specific SSB as a CORESET for UL WUS, or only CORESET #0 at a specific location as a CORESET for UL WUS.

The SSBs are shown in FIG. 20 based on case #3 of FIG. 5 as an example, and the third method may be applied without limitation based on the various SSB resource cases described in embodiments herein.

The CORESET may be defined in the specification as having a time duration of K symbols or M PRBs. The K and M may be natural numbers greater than or equal to 1.

The UE may determine that the CORESET is QCLed to an SSB having the same index. Based on the QCL, the UE may receive the PDCCH or PDSCH required to receive UL WUS configuration information in the CORESET.

Since periodic SIB1 is not transmitted in the on-demand SIB1 cell, the UE may determine that CORESET #0, which is the PDCCH or PDSCH resource information required to receive the periodic SIB1, is not transmitted periodically, and the BS may save energy by not transmitting the CORESET #0 periodically. In addition, the BS may transmit the CORESET and SSB for UL WUS consecutively and save energy in the remaining non-transmission time.

### Method 12

The UE may determine the resource of the corresponding WUS transmission by applying a pre-configured/pre-fixed time/frequency offset with reference to the SSB. The pre-configured/pre-fixed offset may be pre-configured differently for each PCI. Alternatively, the UE may reinterpret the MIB information of the SSB with respect to the on-demand SIB1 cell to determine the resource location for WUS transmission. For example, a specific frequency domain resource allocation (FDRA) and TDRA list table may be pre-configured for WUS resource allocation and determined by being indicated via pdcch-ConfigSIB1 in the MIB. The FDRAs and/or TDRAs within the preconfigured FDRA list table and/or TDRA list table may be indicated by pdcch-ConfigSIB1 of the MIB. The MSB 4 bits of pdcch-ConfigSIB1 may indicate FDRA information, and the LSB 4 bits may indicate TDRA information. Alternatively, the MSB 4 bits of pdcch-ConfigSIB1 may indicate TDRA information, and the LSB 4 bits may indicate FDRA information.

Through the above methods 9, 10, 11 and 12, the UE may receive the resource information required to receive the PDCCH or PDSCH to receive the UL WUS configuration information, and may receive the information required to transmit the UL WUS from the resource information. When the UE transmits the UL WUS and the on-demand SIB1 cell receives the UL WUS, the on-demand SIB1 cell may initiate a transmission for CORESET #0 required for the UE to receive the SIB1.

The UE may transmit a UL signal (e.g., a WUS) requesting an on-demand SIB1 to an on-demand SIB1 cell supporting on-demand SIB1 under the following circumstances.

### Situation 1

When the UE wishes to camp on an on-demand SIB1 cell, the UE may transmit a WUS requesting an on-demand SIB1, as described in FIGS. 16 and 17. After transmitting the WUS requesting the on-demand SIB1, the UE may receive the SIB1 from the on-demand SIB1 cell or cell A and camp on the on-demand SIB1 cell.

### Situation 2

When the UE wishes to perform a random access to the on-demand SIB1 cell to perform an RRC connection to the on-demand SIB1 cell (or to establish an RRC connection), the UE may transmit a WUS requesting on-demand SIB1 as described in FIGS. 16 and 17. After transmitting the WUS requesting the on-demand SIB1, the UE may change to an RRC connected mode (or may transition to the RRC connected mode) after receiving the SIB1 from the on-demand SIB1 cell or cell A to perform a random access to the on-demand SIB1 cell.

The UE may reuse a PRACH preamble and PRACH time/frequency resources for WUS. That is, the UE may be configured via the first higher layer signal/system information or the like, or may be configured via the second higher layer signal/system information or the like from the BS or may implicitly recognize that some of the predetermined PRACH resources may be used for WUS. Herein, the PRACH resources may include PRACH preamble or PRACH time and frequency resources or the like. The first higher layer signal/system information and the second higher layer signal/system information may be the same or different.

A UE having the capability to request an on-demand SIB1 from a WUS may use PRACH resources other than the PRACH resources for the WUS as PRACH resources for random access during the initial access. Since the PRACH resource for WUS is unavailable for random access during the initial access, the probability of collision with other UEs during the random access of the UE may increase, and a delay in random access may occur.

The UE may use the WUS for random access during initial access or random access after an RRC connected mode in addition to requesting an on-demand SIB1. The UE may use the WUS in contention-based random access in addition to requesting an on-demand SIB1. The UE may use the WUS in contention-free random access in addition to requesting the on-demand SIB1. The UE may receive or implicitly recognize (e.g., as defined in the specification) a configuration that the WUS may be used for specific purposes other than requesting an on-demand SIB1, Through higher layer signal/system information from the BS.

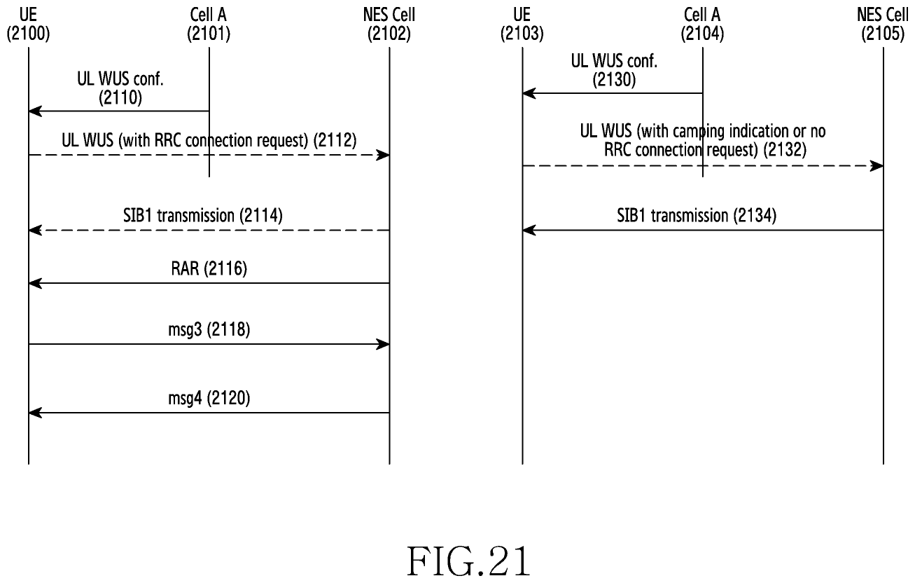

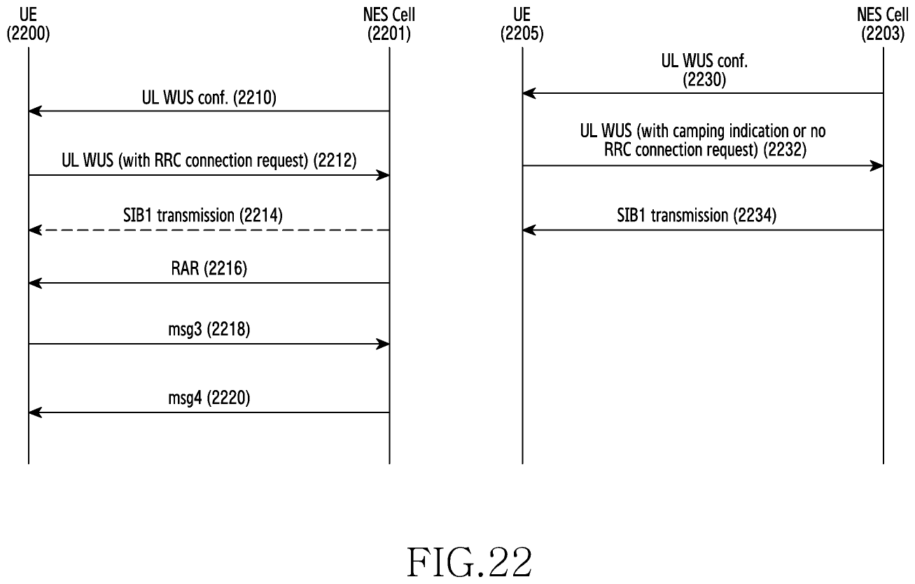

A method of reducing connection delay when receiving SIB1 and camping on an on-demand SIB1 cell or receiving SIB1 and performing random access during initial access, depending on the situation of the UE requesting on-demand SIB1 described above, is provided with reference to FIGS. 21 and 22.

The methods disclosed below may be applied to the on-demand SIB1 operation in the scenarios described in FIGS. 16 and 17.

FIG. 21 illustrates when a UE receives a WUS configuration from a specific cell, and then performs random access or camps on a NES cell during initial access according to information included in a WUS that the UE transmits, according to an embodiment.

Referring to the left side of FIG. 21, after the UE (2100) receives a UL WUS configuration 2110 from a cell A (2101), a WUS 2112 transmitted by the UE may include information to request an RRC connection or information indicating that the UE does not want to camp (or camp on). The UE may transmit the information to the BS through a PRACH resource. The UE may transmit the information to the BS via the WUS by transmitting the WUS using a specific PRACH preamble or by transmitting the WUS using a specific PRACH time/frequency resource.

Thereafter, the UE may receive SIB1 2114 from the BS. Although FIG. 21 illustrates when the SIB1 2114 is transmitted in the next operation after the WUS 2112 is received by a NES cell 2102, the SIB1 2114 may also be transmitted to the UE from the BS via a random access response (RAR) 2116 or Msg4 2120 in a later operation. The SIB1 2114 may be determined (or understood) by the UE as a response that the BS has successfully received the WUS 2112 transmitted by the UE.

Thereafter, the UE may receive the RAR 2116 from the BS. The BS may know from the information included in the WUS 2112 that the UE requires an RRC connection request, and may transmit the RAR 2116 directly to the UE without having to receive a PRACH to perform a random access from the UE in the conventional procedure. That is, in response to the WUS transmission, the UE may detect the DCI format 1_0 during an RA response window (ra-ResponseWindow) and receive the RAR 2116 indicated by the DCI format. The RA response window may start from the first symbol of the earliest CORESET configured in the UE to receive a PDCCH in a Type1-PDCCH CSS set, after the last symbol of a PRACH occasion corresponding to the WUS transmission.

In this case, the RA response window that the UE should apply may be configured to have a different value than the RA response window configured in random access during initial access to the existing UE. That is, since the UE requires time to receive the SIB1 2114 after transmitting the WUS 2112, an RA response window different from that of the existing UE may be required (or may be used). As an example, a value of 10 ms or less in the license band may be configured via the higher layer signal/system information as the RA response window for the existing UE to use in random access during the initial access. In random access via the WUS 2112, the RA response window until reception of the RAR 2116 by the UE may be included in the WUS configuration and received by the UE and can be configured with a separate value (e.g., a value greater than 10 ms) from that for the RA response window to be used by the existing UE in random access during the initial access.

Thereafter, the UE may transmit msg3 2118 to the BS, and the UE may then receive Msg4 2120 from the BS to complete the random access.

On the right side of FIG. 21, after the UE (2103) receives a UL WUS configuration 2130 from a cell A (2104), a WUS 2132 transmitted by the UE may include information indicating that the UE does not want to request an RRC connection or information indicating that the UE wants to camp. The UE may transmit this information through a PRACH resource via a WUS by transmitting a WUS using a specific PRACH preamble, or by transmitting the WUS using a specific PRACH time/frequency resource. The UE may then receive SIB1 2134 from the BS to camp on a NES cell 2105. Thereafter, when the UE requires an RRC connection to the NES cell 2105, random access may be triggered by the UE or the BS. The UE may use the WUS resource by a WUS configuration as the PRACH resource for random access, or may use a PRACH resource for random access configured by the SIB1 or defined in the specification.

FIG. 22 illustrates when a UE receives a WUS configuration from a specific cell, and then performs random access or camps on a NES cell during initial access according to information included in a WUS that the UE transmits, according to an embodiment.

Referring to the left side of FIG. 22, after receiving a WUS configuration 2210 from the NES cell 2201, a WUS 2212 transmitted by the UE 2200 may include information to request an RRC connection or information that the UE does not want to camp (or camp on). The UE may transmit the information to the BS through a PRACH resource. The UE may transmit the information to the BS via the WUS by transmitting the WUS using a specific PRACH preamble or by transmitting the WUS using a specific PRACH time/frequency resource.

Thereafter, the UE may receive SIB1 2214 from the BS. Although FIG. 22 illustrates when the SIB1 2214 is transmitted in the next operation after the WUS 2212 is received by a NES cell 2201, the SIB1 2214 may also be transmitted to the UE from the BS via a RAR 2216 or Msg4 2220 in a later operation. The SIB1 2214 may be determined (or understood) by the UE as a response that the BS has successfully received the WUS 2212 transmitted by the UE.

Thereafter, the UE may receive the RAR 2216 from the BS. The BS may know from the information included in the WUS 2212 that the UE requires an RRC connection request and may transmit the RAR 2216 directly to the UE without having to receive a PRACH to perform a random access from the UE in the conventional procedure. That is, in response to the WUS transmission, the UE may detect the DCI format 1_0 during an RA response window and receive the RAR 2216 indicated by the DCI format. The RA response window may start from the first symbol of the earliest CORESET configured in the UE to receive a PDCCH in a Type1-PDCCH CSS set, after the last symbol of a PRACH occasion corresponding to the WUS transmission.

In this case, the RA response window that the UE should apply may be configured to have a value different from the RA response window configured in random access during initial access to the existing UE. Since the UE requires time to receive the SIB1 2214 after transmitting the WUS 2212, an RA response window different from that of the existing UE may be required (or may be used). For example, a value of 10 ms or less in the license band may be configured via the higher layer signal/system information as the RA response window for the existing UE to use in random access during the initial access. In random access via the WUS 2212, the RA response window until reception of the RAR 2116 by the UE may be included in the WUS configuration and received by the UE and can be configured with a separate value (e.g., a value greater than 10 ms) from that for the RA response window to be used by the existing UE in random access during the initial access.

Thereafter, the UE may transmit msg3 2218 to the BS, and the UE may then receive Msg4 2220 from the BS to complete the random access.

On the right side of FIG. 22, after receiving a WUS configuration 2230 from the NES cell 2203, a WUS 2232 transmitted by the UE 2205 may include information indicating that the UE does not want to request an RRC connection or information indicating that the UE wants to camp. The UE 2205 may transmit this information through a PRACH resource via the WUS by transmitting a WUS using a specific PRACH preamble, or by transmitting the WUS using a specific PRACH time/frequency resource. The UE 2205 may then receive SIB1 2234 from the BS to camp on a NES cell 2203. Thereafter, when the UE requires an RRC connection to the NES cell 2203, random access may be triggered by the UE or the BS. The UE may use a WUS resource by the WUS configuration as the PRACH resource for random access, or may use a PRACH resource for random access configured by the SIB1 or defined in the specification. The RA response window that the UE should apply for the random access may be the RA response window configured in the random access during initial access to the existing UE.

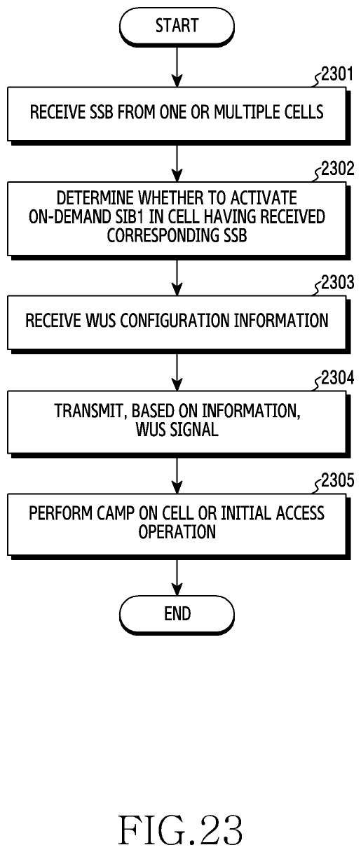

FIG. 23 illustrates a UE operation of applying an energy saving method of a wireless communication system according to an embodiment. Although FIG. 23 is illustrated as a series of operations, the various operations of the illustrated method may overlap, occur in parallel, occur in different sequences, or occur multiple times.

Referring to FIG. 23, in step 2301, the UE may receive SSB from the BS via one or multiple cells.

In step 2302, the UE may determine whether to activate on-demand SIB1 in a cell that has received the corresponding SSB.

In step 2303, the UE may receive WUS configuration information, based on the methods described in embodiments herein.

In step 2304, the UE may, based on the above information, transmit a WUS signal in the manner described herein.

In step 2305, the UE may receive an on-demand SIB1 from the corresponding cell and camp on the cell, or perform an initial access and random access operation in the manner described herein.

For specific details of the UE operation, reference may be made to the foregoing descriptions.

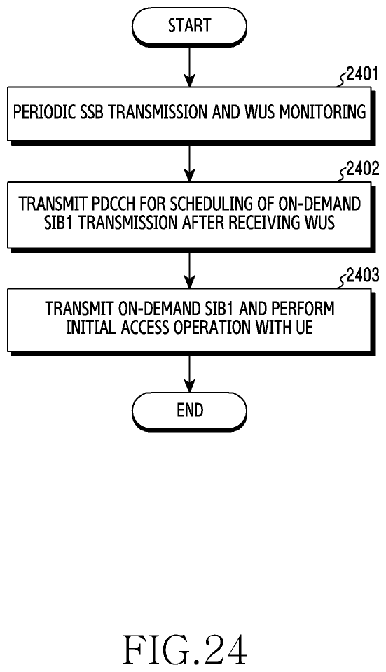

FIG. 24 illustrates a BS operation of applying an energy saving method of a wireless communication system according to an embodiment.

Referring to FIG. 24, in step 2401, the BS may perform periodic SSB transmissions to the UE, and may perform WUS monitoring based on the WUS configuration information established according to embodiments of the disclosure. The BS may transmit the WUS configuration information based on the methods described in embodiments herein.

In step 2402, the BS may transmit a PDCCH for scheduling of on-demand SIB1 transmission after receiving the WUS from the UE as described herein.

In step 2403, the BS may transmit on-demand SIB1 to the UE, and perform an initial access and random access operation with the UE as described herein.

For specific details of the BS operation, reference may be made to the foregoing descriptions.

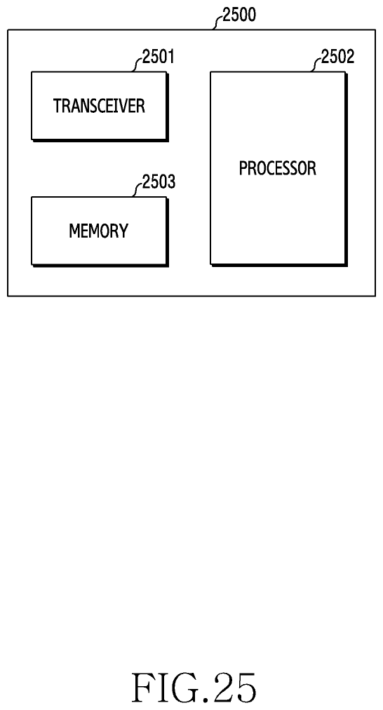

FIG. 25 is a block diagram of a UE according to an embodiment.

Referring to FIG. 25, the UE 2500 may include a transceiver 2501, a controller (for example, processor) 2502, and a memory 2503. The transceiver 2501, the controller 2502, and the memory 2504 of the UE 2500 may operate according to at least one or a combination of methods corresponding to the above-described embodiments. However, components of the UE 2500 are not limited to the illustrated example and the UE 2500 may include fewer or more components than the above-described components. The transceiver 2501, the controller 2502, and the memory 2503 may be implemented in the form of a single chip.

The transceiver 2501 may include a transmitter and a receiver. The transceiver 2501 may transmit/receive signals with the BS. The signals may include control information and data. The transceiver 2501 may include an RF transmitter configured to up-convert and amplify the frequency of transmitted signals, and an RF receiver configured to low-noise-amplify received signals and down-convert the frequency thereof. The transceiver 2501 may receive signals through a radio channel, output the same to the controller 2502, and transmit signals output from the controller 2502 through the radio channel.

The controller 2502 may control a series of processes such that the UE 2500 can operate according to the above-described embodiments. The controller 2502 may perform or control the UE's operations for performing at least one or a combination of the methods of the disclosure. The controller 2502 may include at least one processor. The controller 2502 may include a communication processor which performs control for communication and an application processor (AP) which controls upper layers (for example, applications).

The memory 2503 may store control information (for example, channel estimation-related information using DMRSs transmitted in a PUSCH included in a signal acquired by the UE 2500) or data, and may have a region for storing data necessary for control of the controller 2502 and data produced during control by the controller 2502.

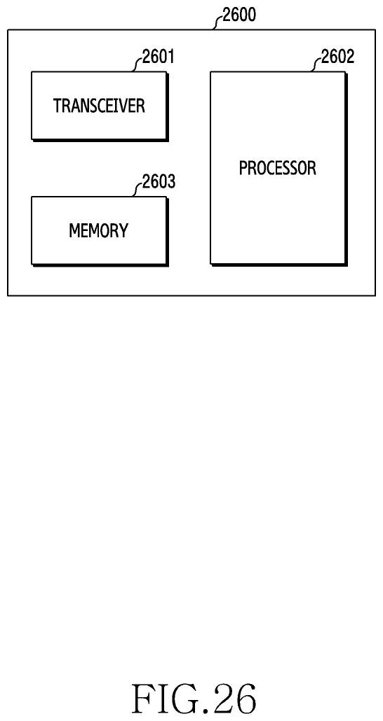

FIG. 26 is a block diagram of a BS according to an embodiment.

Referring to FIG. 26, the BS 2600 may include a transceiver 2601, a controller (e.g., processor) 2602, and a memory 2603. The transceiver 2601, the controller 2602, and the memory 2604 of the BS 2600 may operate according to at least one or a combination of methods corresponding to the above-described embodiments. However, components of the BS 2600 are not limited to the above-described example and may include fewer or more components than the above-described components. The transceiver 2601, the controller 2602, and the memory 2603 may be implemented in the form of a single chip.

The transceiver 2601 may include a transmitter and a receiver. The transceiver 2601 may transmit/receive signals with the UE. The signals may include control information and data. The transceiver 2601 may include an RF transmitter configured to up-convert and amplify the frequency of transmitted signals, and an RF receiver configured to low-noise-amplify received signals and down-convert the frequency thereof. The transceiver 2601 may receive signals through a radio channel, output the same to the controller 2602, and transmit signals output from the controller 2602 through the radio channel.

The controller 2602 may control a series of processes such that the BS can operate according to the above-described embodiments. The controller 2602 may perform or control the BS's operations for performing at least one or a combination of the methods according to embodiments of the disclosure. The controller 2602 may include at least one processor. The controller 2602 may include a communication processor which performs control for communication and an AP which controls upper layers (for example, applications).

The memory 2603 may store control information (for example, channel estimation-related information generated using DMRSs transmitted in a PUSCH determined by the BS 2600), data, and control information or data received from the UE, and may have a region for storing data necessary for control of the controller 2602 and data produced during control by the controller 2602.

Although the drawings illustrate different examples of a UE and a BS, various changes and modifications may be made to the drawings. For example, a UE and a BS may each include any number of components in any appropriate deployment.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block in the flowchart illustrations may represent a module, segment, or portion of code, which includes one or more executable instructions for implementing the specified logical function(s). In some alternative implementations, the functions noted in the blocks may occur out of order. Two blocks shown in succession may in fact be executed substantially concurrently or the blocks may be executed in the reverse order, depending upon the functionality involved.

As used herein, the term unit refers to a software element or a hardware element, such as a field programmable gate array (FPGA) or an application specific integrated circuit (ASIC), and the unit may perform certain functions. However, the unit does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into fewer elements, or a unit, or divided into more elements, or a unit. Moreover, the elements and units may be implemented to reproduce one or more central processing units within a device or a security multimedia card. The unit may also include one or more processors.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), Wide LAN (WLAN), and storage area network (SAN) or a combination thereof. Such a storage device may access the electronic device via an external port. A separate storage device on the communication network may access a portable electronic device.

The methods described above in conjunction with the figures herein may include methods in which one or more drawings are combined according to various implementations. For example, the embodiments described herein may be combined to be connected (performed) as one flow. In addition, all or a part of an embodiment may be performed in combination with all or a part of one or more other embodiments. The disclosure may include methods in which one or more of the drawings are combined according to various implementations.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal in a wireless communication system, the method comprising:
receiving, from a first base station (BS), configuration information on an uplink (UL) wake-up signal (WUS) for a second BS;
transmitting, to the second BS, the UL WUS for requesting a system information block 1 (SIB1) associated with the second BS;
receiving, from the second BS, a random access response based on the UL WUS; and
receiving, from the second BS, the SIB1.

2. The method of claim 1,
wherein the UL WUS is transmitted with an indication associated with a radio resource control (RRC) connection request.

3. The method of claim 2, further comprising:
transmitting, to the second BS, a message 3 for the RRC connection request; and
receiving, from the second BS, a message 4.

4. The method of claim 1,
wherein the UL WUS is transmitted with an indication associated with a camp on for the second BS.

5. The method of claim 1,
wherein the second BS is associated with a network energy saving (NES) cell, and
wherein the first BS is associated with an anchor cell for the NES cell.

6. A method performed by a second base station (BS) in a wireless communication system, the method comprising:
receiving, from a terminal, an uplink (UL) wake-up signal (WUS) for requesting a system information block 1 (SIB1) associated with the second BS, the UL WUS being based on configuration information on the UL WUS;
transmitting, to the terminal, a random access response based on the UL WUS; and
transmitting, to the terminal, the SIB1.

7. The method of claim 6,
wherein the UL WUS is received with an indication associated with a radio resource control (RRC) connection request.

8. The method of claim 7, further comprising:
receiving, from the terminal, a message 3 for the RRC connection request; and
transmitting, to the terminal, a message 4.

9. The method of claim 6,
wherein the UL WUS is received with an indication associated with a camp on for the second BS.

10. The method of claim 6,
wherein the second BS is associated with a network energy saving (NES) cell, and
wherein the configuration information is coordinated with a first BS associated with an anchor cell for the NES cell.

11. A terminal in a wireless communication system, the terminal comprising:
a transceiver; and
a controller coupled with the transceiver and configured to:
receive, from a first base station (BS), configuration information on an uplink (UL) wake-up signal (WUS) for a second BS,
transmit, to the second BS, the UL WUS for requesting a system information block 1 (SIB1) associated with the second BS,
receive, from the second BS, a random access response based on the UL WUS, and
receive, from the second BS, the SIB1.

12. The terminal of claim 11,
wherein the UL WUS is transmitted with an indication associated with a radio resource control (RRC) connection request.

13. The terminal of claim 12,
wherein the controller is further configured to:
transmit, to the second BS, a message 3 for the RRC connection request, and
receive, from the second BS, a message 4.

14. The terminal of claim 11,
wherein the UL WUS is transmitted with an indication associated with a camp on for the second BS.

15. The terminal of claim 11,
wherein the second BS is associated with a network energy saving (NES) cell, and
wherein the first BS is associated with an anchor cell for the NES cell.

16. A second base station (BS) in a wireless communication system, the second BS comprising:
a transceiver; and
a controller coupled with the transceiver and configured to:
receive, from a terminal, an uplink (UL) wake-up signal (WUS) for requesting a system information block 1 (SIB1) associated with the second BS, the UL WUS being based on configuration information on the UL WUS,
transmit, to the terminal, a random access response based on the UL WUS, and
transmit, to the terminal, the SIB1.

17. The second BS of claim 16,
wherein the UL WUS is received with an indication associated with a radio resource control (RRC) connection request.

18. The second BS of claim 17,
wherein the controller is further configured to:
receive, from the terminal, a message 3 for the RRC connection request, and
transmit, to the terminal, a message 4.

19. The second BS of claim 16,
wherein the UL WUS is received with an indication associated with a camp on for the second BS.

20. The second BS of claim 16,
wherein the second BS is associated with a network energy saving (NES) cell, and
wherein the configuration information is coordinated with a first BS associated with an anchor cell for the NES cell.
